(19) United States
(12) Patent Application Publication
(10) Pub. No.: US 2025/0142319 A1
(43) Pub. Date: May 1, 2025

(54) ACKNOWLEDGMENT (ACK) PROCESSING ASSOCIATED WITH MEDIUM ACCESS CONTROL (MAC) HEADER VERIFICATION, PAYLOAD VERIFICATION, OR BOTH

(71) Applicant: QUALCOMM Incorporated, San Diego, CA (US)

(72) Inventors: Abhishek Pramod PATIL, San Diego, CA (US); Sai Yiu Duncan HO, San Diego, CA (US); Alfred ASTERJADHI, San Diego, CA (US); George CHERIAN, San Diego, CA (US); Gaurang NAIK, San Diego, CA (US); Naveen Kumar KAKANI, Flower Mound, TX (US); Niranjan REGATTE, San Ramon, CA (US); Nandkishore PAI, Allen, TX (US); Chao ZOU, San Jose, CA (US)

(21) Appl. No.: 18/500,027

(22) Filed: Nov. 1, 2023

(51) Int. Cl. H04W 8/22; H04L 5/00

(52) U.S. Cl. CPC H04W 8/22; H04L 5/0053

(57) ABSTRACT

This disclosure provides methods, components, devices, and systems for acknowledgment (ACK) processing associated with medium access control (MAC) header verification, payload verification, or both. Some aspects more specifically relate to a first wireless device advertising a processing capability associated with performing MAC protocol data unit (MPDU) verification, including MAC header verification, payload verification, or both. In some implementations, the processing capability may include a processing latency to perform the verification, a threshold quantity of MPDUs supported for the verification within a short interframe spacing (SIFS) time interval, or both. The first wireless device may transmit an indication of the processing capability to a second wireless device. In some implementations, the second wireless device may transmit MPDUs to the first wireless device in accordance with the processing capability. Additionally, or alternatively, the first wireless device may transmit an ACK frame for the MPDUs in accordance with the processing capability.

### TECHNICAL FIELD

This disclosure relates to wireless communication and, more specifically, to acknowledgment (ACK) processing associated with medium access control (MAC) header verification, payload verification, or both.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a first wireless device may provide feedback to a second wireless device within a configured time interval, such as a short interframe spacing (SIFS) time interval. The feedback may be associated with a frame check sequence (FCS), such that the first wireless device may generate an acknowledgment (ACK) frame within the SIFS time interval. However, in some implementations, a medium access control (MAC) protocol data unit (MPDU) may pass an FCS check but fail a subsequent check, resulting in inaccurate feedback for the MPDU.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless device. The wireless device may include a processing system that includes processor circuitry and memory circuitry that stores code. The processing system may be configured to cause the wireless device to output an indication of a processing capability associated with verification of a medium access control (MAC) header, a payload, or both, the processing capability being either a processing latency associated with the verification, or a threshold quantity of MAC protocol data units (MPDUs) supported for the verification within a short interframe spacing (SIFS) time interval, or both the processing latency and the threshold quantity of MPDUs. The processing system may be further configured to cause the wireless device to obtain one or more MPDUs that solicit an acknowledgment (ACK) frame and output the ACK frame in accordance with the processing capability.

Another innovative aspect of the subject matter described in this disclosure can be implemented in a method for wireless communication by a wireless device. The method may include transmitting an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The method may further include receiving one or more MPDUs that solicit an ACK frame and transmitting the ACK frame in accordance with the processing capability.

Another innovative aspect of the subject matter described in this disclosure can be implemented in an apparatus for wireless communications. The apparatus may include means for transmitting an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The apparatus may further include means for receiving one or more MPDUs that solicit an ACK frame and means for transmitting the ACK frame in accordance with the processing capability.

Another innovative aspect of the subject matter described in this disclosure can be implemented in a non-transitory computer-readable medium storing code for wireless communications. The code may include instructions executable by a processor to transmit an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The code may further include instructions executable by the processor to receive one or more MPDUs that solicit an ACK frame and transmit the ACK frame in accordance with the processing capability.

In some examples of the wireless device, method, apparatus, and non-transitory computer-readable medium described herein, a duration associated with the one or more MPDUs may be extended according to the processing capability.

Some examples of the wireless device, method, apparatus, and non-transitory computer-readable medium described herein may further include operations, features, means, or instructions for verifying one or more MAC headers, one or more payloads, or both corresponding to the one or more MPDUs and performing duplicate detection in accordance with the verifying the one or more MAC headers, the one or more payloads, or both, where the ACK frame indicates a result of the duplicate detection.

Another innovative aspect of the subject matter described in this disclosure can be implemented in a wireless device. The wireless device may include a processing system that includes processor circuitry and memory circuitry that stores code. The processing system may be configured to cause the wireless device to obtain an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The processing system may be further configured to cause the wireless device to output one or more MPDUs that solicit an ACK frame and obtain the ACK frame in accordance with the processing capability.

Another innovative aspect of the subject matter described in this disclosure can be implemented in a method for wireless communications by a wireless device. The method may include receiving an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The method may further include transmitting one or more MPDUs that solicit an ACK frame and receiving the ACK frame in accordance with the processing capability.

Another innovative aspect of the subject matter described in this disclosure can be implemented in an apparatus for wireless communications. The apparatus may include means for receiving an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The apparatus may further include means for transmitting one or more MPDUs that solicit an ACK frame and means for receiving the ACK frame in accordance with the processing capability.

Another innovative aspect of the subject matter described in this disclosure can be implemented in a non-transitory computer-readable medium storing code for wireless communications. The code may include instructions executable by a processor to receive an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The code may further include instructions executable by the processor to transmit one or more MPDUs that solicit an ACK frame and receive the ACK frame in accordance with the processing capability.

Some examples of the wireless device, method, apparatus, and non-transitory computer-readable medium described herein may further include operations, features, means, or instructions for extending a duration associated with the one or more MPDUs according to the processing capability.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example physical layer (PHY) protocol data unit (PPDU) usable for communications between a wireless access point (AP) and one or more wireless stations (STAs).

FIG. 3 shows an example of a signaling diagram that supports acknowledgment (ACK) processing associated with medium access control (MAC) header verification, payload verification, or both.

FIG. 4 shows an example of MAC service data unit (MSDU) processing that supports MAC header verification, payload verification, or both.

FIG. 5 shows a flowchart illustrating an example process performable by or at a wireless device that supports MAC header and payload integrity checks.

FIGS. 6A, 6B, and 6C show examples of timelines that support ACK frame transmission with MAC header verification, payload verification, or both.

FIG. 7 shows an example of a process flow that supports ACK processing associated with MAC header verification, payload verification, or both.

FIG. 8 shows a block diagram of an example wireless communication device that supports ACK processing associated with MAC header verification, payload verification, or both.

FIGS. 9 and 10 show flowcharts illustrating example processes performable by or at a wireless device that support ACK processing associated with MAC header verification, payload verification, or both.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to processing associated with medium access control (MAC) header verification, payload verification, or both, for MAC protocol data units (MPDUs) before transmission of an acknowledgment frame (such as a Blockack frame or an Ack frame) referred to as an ACK frame herein. Some aspects more specifically relate to a wireless device advertising a processing capability relating to the wireless device performing MAC header verification, payload verification, or both. In some implementations, a first wireless device (such as a wireless station (STA) or a wireless access point (AP)) may transmit an indication of a processing capability of the first wireless device to perform a verification for an MPDU, the verification including MAC header verification, payload verification, or both. In some implementations, the processing capability may be an example of a processing latency for the first wireless device to perform the verification for the MPDU. Additionally, or alternatively, the processing capability may be an example of a quantity of MPDUs for which the first wireless device may perform the verification within a short interframe spacing (SIFS) time interval. The first wireless device may perform the verification and may transmit an ACK frame according to the verification and the processing capability. In some implementations, a second wireless device (such as an AP or a STA) transmitting one or more MPDUs to the first wireless device may extend a duration of the one or more MPDUs according to the processing capability of the first wireless device, such that the first wireless device may transmit a solicited ACK frame within the SIFS time interval. In some other implementations, the first wireless device may delay transmission of the ACK frame to occur after an end of the SIFS time interval according to the processing capability. In some implementations, the first wireless device may transmit a first ACK frame within the SIFS time interval (such as a null ACK frame or an ACK frame that indicates frame check sequence (FCS)-based verification, MAC header-based verification, or both) and may transmit a second ACK frame after the end of the SIFS time interval that indicates MAC header-based verification, payload-based verification, or both. The first wireless device may additionally, or alternatively, perform duplicate detection in accordance with results of the MAC header verification, the payload verification, or both.

Particular aspects of the subject matter described in this disclosure can be implemented to realize one or more of the following potential advantages. In some implementations, in accordance with the first wireless device advertising its processing capability, the described techniques can be used to support ACK frame transmission that accommodates the processing capability of the first wireless device. For example, by extending the duration of one or more MPDUs, the wireless device receiving the MDPUs may perform the MAC header verification, the payload verification, or both during the extended duration, such that the wireless device supports transmitting the ACK frame within the SIFS time interval after the extended MPDUs. In some implementations, by delaying transmission of the ACK frame beyond the SIFS time interval, the wireless device may perform the MAC header verification, the payload verification, or both in time to generate and transmit the ACK frame. In some implementations, by transmitting a first ACK frame within the SIFS time interval that includes FCS-based feedback, MAC header-based feedback, or both and a second ACK frame after the SIFS time interval that includes MAC header-based feedback (such as if the first ACK frame fails to include the MAC header-based feedback), payload-based feedback (such as if the first ACK frame includes the MAC header-based feedback), or both, the wireless device may support both the SIFS time interval for providing feedback (such as using the first ACK frame) while also supporting MAC header-based or payload-based feedback (such as using the second ACK frame). Transmitting the ACK frame indicating the MAC header verification, payload verification, or both mitigates denial of service (DOS) attacks that FCS-based verification may be susceptible to. Additionally, or alternatively, by performing duplicate detection in accordance with the MAC header verification, the payload verification, or both (as opposed to in accordance with FCS verification), the wireless device may protect against other DOS attacks and provide an accurate, or otherwise complete, status of the reception. Additionally, or alternatively, performing ACK frame transmission, duplicate detection, or both in accordance with the MAC header verification, the payload verification, or both may help ensure that the state of an MPDU is in sync at both the transmitter device and the recipient device.

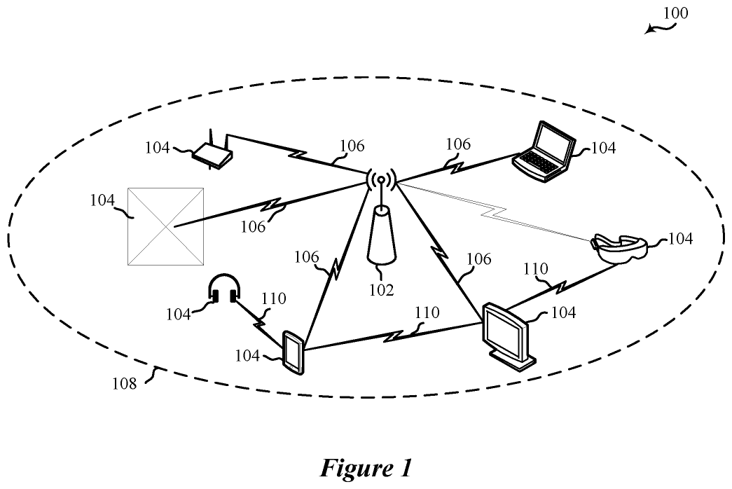

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other implementations, the wireless communication network 100 can be an example of a cellular radio access network (RAN), such as a 5G or 6G RAN that implements one or more cellular protocols such as those specified in one or more 3GPP standards. In some other implementations, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some aspects, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHZ-24.25 GHz), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHZ, 240 MHZ, 320 MHz, 480 MHz, or 640 MHz by bonding together multiple 20 MHz channels.

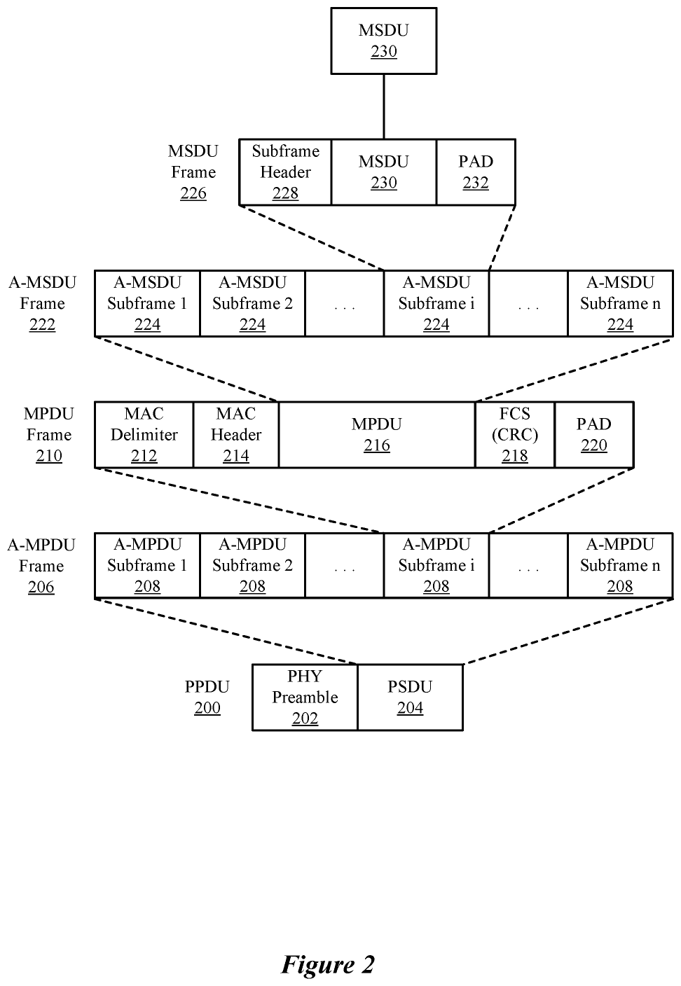

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MPDUs 216. For example, each PSDU 204 may carry an aggregated MPDU (A-MPDU) 206 that includes an aggregation of multiple A-MPDU subframes 208. Each A-MPDU subframe 206 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (the FCS field may include a cyclic redundancy check (CRC)) and padding bits 220. The MPDU 216 may carry one or more MAC service data units (MSDUs) 230. For example, the MPDU 216 may carry an aggregated MSDU (A-MSDU) 222 including multiple A-MSDU subframes 224. Each A-MSDU subframe 224 may be associated with (such as an example of or otherwise referred to as) an MSDU frame 226 and may contain a corresponding MSDU 230 preceded by a subframe header 228 and in some implementations followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an ACK or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 214 also includes one or more fields indicating addresses for the data encapsulated within the frame body. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a CRC. The error checking bits may be used by the receiving device to determine if it has properly decoded the received HARQ transmission. In some implementations, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some implementations, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

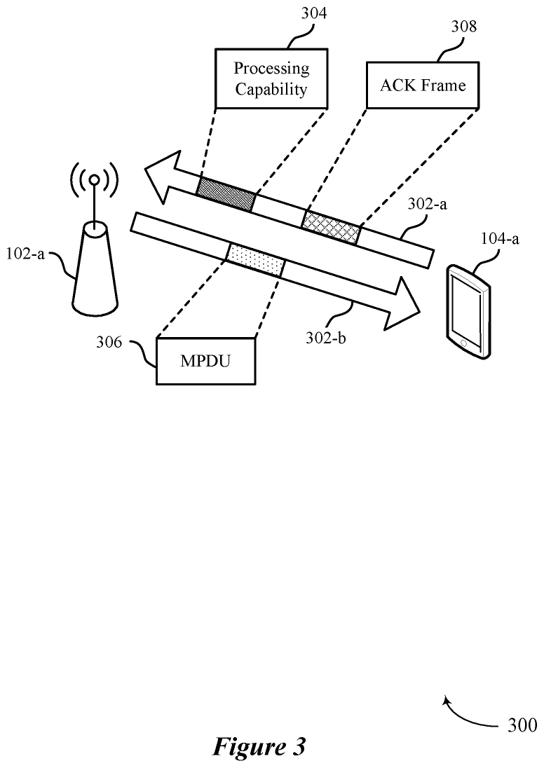

FIG. 3 shows an example of a signaling diagram that supports ACK processing associated with MAC header verification, payload verification, or both. The signaling diagram may include a wireless communication network 300, such as a WLAN or Wi-Fi network. The wireless communication network 300 may support communications between different wireless devices, such as an AP 102-a and a STA 104-a, which may be examples of an AP 102 and a STA 104 as described herein with reference to FIG. 1. The wireless communication network 300 may support feedback operations including MAC header verification, payload verification, or both. As illustrated in FIG. 3, the STA 104-a may transmit feedback (such as an ACK frame 308) to the AP 102-a in accordance with the supported feedback operations. Additionally, or alternatively, the wireless communication network 300 may support the AP 102-a transmitting feedback to the STA 104-a, the AP 102-a transmitting feedback to another AP 102, or the STA 104-a transmitting feedback to another STA 104.

An originator device (such as an AP 102 or a STA 104) may transmit one or more MPDUs 306 to a recipient device (such as a STA 104 or an AP 102). For example, the AP 102-a may transmit one or more MPDUs 306 to the STA 104-a, where the one or more MPDUs 306 solicit an ACK in response to the one or more MPDUs 306. The ACK (such as an ACK frame 308) from the recipient device may serve as feedback to the originator device (such as a transmitter device). The feedback may indicate successful reception or failed reception for the one or more MPDUs 306. For example, the feedback can indicate different statuses for different MPDUs of the one or more MPDUs 306. According to the feedback, the originator device may perform one or more actions. For example, if the feedback indicates that the recipient device failed to receive a first MPDU, the originator device may retry transmitting the first MPDU, may increase a backoff window, may adjust a data rate to retransmit the first MPDU (in some implementations, reduce the data rate to a relatively more conservative data rate), or any combination thereof. If the feedback indicates that the recipient device successfully received a second MPDU, the originator device may clear the successfully received second MPDU from a transmit buffer of the originator device, may adjust a data rate for transmissions (in some implementations, increase a transmission rate), or both.

Different systems or devices may use different operations to determine whether an MPDU is successfully received. In some implementations, a recipient device may provide feedback in accordance with a frame check sequence (FCS) check. An FCS may be an example of an error-detecting code. An originator device may calculate an FCS value using the contents of a frame and may include the FCS value within (such as at the end of) the frame. A recipient device may similarly calculate an FCS value using the received frame and may compare the calculated FCS value to the FCS value received in the frame. If the FCS values match, the recipient device may determine that the frame passes the FCS check. In some implementations, the recipient device may update a scoreboard, or any other mechanism for tracking MPDU reception, in accordance with the FCS check. For example, the recipient device may update the scoreboard context to indicate that an MPDU is successfully received if the MPDU passes the FCS check. The scoreboard may include a first bit value (such as 1) associated with a first sequence number (SN) of an MPDU to indicate successful reception of the MPDU with the first SN or may include a second bit value (such as 0) associated with the first SN to indicate unsuccessful reception of the MPDU with the first SN. In some aspects, the recipient device may use the scoreboard to perform duplicate detection. For example, if the recipient device receives an MPDU with an SN for which the scoreboard already indicates successful reception (such as if the scoreboard includes the first bit value indicating successful reception at a bit position corresponding to the SN of the received MPDU), the recipient device may discard the received MPDU. Additionally, or alternatively, the recipient device may use the scoreboard for generating or transmitting feedback. The recipient device may indicate whether an MPDU is successfully or unsuccessfully received according to whether the MPDU passes the FCS check. For example, an ACK frame may indicate one or more statuses of whether FCS checks for one or more MPDUs are successful.

Performing an FCS check may involve relatively low latency, such that the recipient device may perform the FCS check and transmit feedback in accordance with the result of the FCS check within a SIFS time window. For example, the recipient device may meet a timing threshold for providing feedback, such as 16 microseconds (μs) or some other timing threshold for providing feedback. In some implementations, the recipient device may provide feedback in accordance with other timing mechanisms or feedback procedures, which may support any timing value or range of timing values for the recipient device to transmit feedback. However, “successful” reception of an MPDU according to a successful FCS check may fail to reflect the status of MAC header validation, payload validation, or both for the MPDU. For example, feedback indicating the results of an FCS check for an MPDU may fail to indicate whether a MAC header of the MPDU was correctly decrypted, passed an integrity check, or passed a replay check, whether a payload of the MPDU was correctly decrypted, passed an integrity check, or passed a replay check, or any combination thereof. An MPDU that passes the FCS check may possibly fail one or more subsequent validations (such as during MAC header validation or payload validation). However, if the recipient device transmits feedback in accordance with the FCS check, the recipient device may report successful reception of such an MPDU to the originator device. Accordingly, in some implementations, the originator device may fail to retransmit the MPDU to the recipient device because the feedback indicates successful reception of the MPDU. Additionally, or alternatively, if the originator device does retransmit the MPDU, the recipient device may drop, or otherwise stop or refrain from receiving, decoding, or processing, the retransmission due to duplicate detection logic and the recipient device marking the MPDU as successfully received (according to the FCS check).

In some systems, an attacker may potentially exploit such operations to cause a DOS attack. In some implementations, the attacker (a rogue device) may use valid SNs but invalid payloads (such as repeated or fake payloads) to “poison” the scoreboard context at a recipient device, causing the DoS attack. In some implementations, the SN of an MPDU may be included in an unprotected MAC header of the MPDU (the SN may be included as plain text), such that the rogue device detecting the MPDU may determine the SN of a current MPDU transmission. The rogue device may select an SN value greater than the SN of the current MPDU transmission in order to block the recipient device from receiving a future MPDU with the selected SN value.

For example, the rogue device may receive and record an MPDU transmitted by an originator device. The rogue device may retransmit or otherwise replay the MPDU with an altered SN (the selected SN value) to the recipient device to cause a DoS at the recipient device. Additionally, or alternatively, the rogue device may transmit a fake MPDU with a valid SN (the selected SN value) to the recipient device. The recipient device may receive the MPDU from the rogue device and may determine or otherwise ascertain that the MPDU passes an FCS check. For example, the MPDU may pass the FCS check because the rogue device did not modify or corrupt the payload or FCS value of the retransmitted MPDU or because the rogue device selected a fake MPDU with a correct FCS value. The recipient device may update a scoreboard or other mechanism for tracking MPDU reception to indicate that the recipient device successfully received the MPDU with the selected SN value. The recipient device may additionally transmit feedback indicating successful reception of the MPDU with the selected SN value. In some implementations, the originator device may ignore or otherwise refrain from receiving or processing such feedback because the originator device may not be monitoring for feedback from the recipient device for an MPDU with the selected SN value. For example, because the originator device has not yet transmitted an MPDU with the selected SN value, the feedback from the recipient device may be unsolicited. In some other implementations, the rogue device may block the feedback from the recipient device to the originator device.

The MPDU received from the rogue device may fail further verification processes at the recipient device. For example, a replayed MPDU may fail a packet number (PN)-based replay check because the recipient device previously received the payload of the MPDU. Additionally, or alternatively, a fake MPDU may fail decryption or an integrity check according to a message integrity code (MIC) check for the fake MPDU. However, if the scoreboard of the recipient device is updated according to the FCS check, the scoreboard context may indicate successful reception for the selected SN value (despite the MPDU failing further verification). Accordingly, if the originator device transmits a genuine MPDU with an SN matching the selected SN value, the recipient device may discard the genuine MPDU due to the duplicate detection logic indicating that the genuine MPDU is a duplicate MPDU (such as according to the scoreboard context indicating that the recipient device already successfully received an MPDU with this SN). In some implementations, the recipient device may resend the feedback indicating successful reception of the MPDU with the selected SN value in accordance with the scoreboard at the recipient device, effectively resulting in the DoS at the recipient device.

Some systems may support MAC header protection. For example, MAC header protection may allow a recipient device to verify one or more fields of a MAC header of an MPDU, such as an aggregate-Control (A-Control) field, a power management bit field, or any other MAC header field. In some implementations, processing time for performing MAC header validation may exceed a SIFS time window, such that a recipient device may perform feedback not accounting for the MAC header validation within the SIFS time window. Such feedback without MAC header validation may be susceptible to the recorded MPDU or fake MPDU DOS attacks. In some other implementations, a recipient device may perform MAC header validation within the SIFS time window and may transmit feedback associated with the MAC header validation. Such feedback may still be susceptible to a jam, record, and replay DOS attack. For example, a rogue device may receive and record an MPDU and may jam the recipient device to cause the recipient device to fail to receive the MPDU. The rogue device may modify a payload of the recorded MPDU while leaving the MAC header of the recorded MPDU unchanged. The rogue device may transmit or otherwise replay the recorded MPDU with the modified payload and unmodified MAC header. The recipient device may receive the MPDU, determine, or otherwise verify or validate, that the MPDU passes an FCS check, a MAC header verification, or both, and may mark the MPDU as successfully received. However, the MPDU may fail a further payload validation and the jam, record, and replay attack may cause a DoS at the recipient device.

The wireless communication network 300 may support enhanced security features to mitigate such attacks. For example, the STA 104-a may perform feedback operations, duplicate detection, or both associated with MAC header verification, payload verification, or both. In some implementations, the STA 104-a may update a scoreboard to reflect the status of an MPDU according to MAC header verification, payload verification, or both, and the STA 104-a may perform duplicate detection, ACK frame 308 transmission, or both according to the scoreboard. For example, the STA 104-a may perform a MAC header integrity check, a payload decryption and integrity check, a PN-based replay check, or a combination thereof on a received MPDU to determine whether the MPDU is successfully received. These verifications beyond an FCS check may support the STA 104-a accurately determining whether the MPDU, including the MAC header and payload, are successfully received. The STA 104-a may transmit an ACK frame 308 indicating the additional verifications.

Performing one or more of these additional verifications may involve additional processing at the STA 104-a prior to transmitting the ACK frame 308. A processing capability 304 of the STA 104-a may indicate whether the STA 104-a can perform the additional processing within a SIFS time interval. The STA 104-a may transmit an indication of the processing capability 304 to the AP 102-a via a link 302-a. In some implementations, the processing capability 304 may be an example of a processing latency associated with performing MAC header verification at the STA 104-a, payload verification at the STA 104-a, or both. Additionally, or alternatively, the processing capability 304 may be an example of a threshold quantity of MPDUs that the STA 104-a can verify (such as using MAC header verification, payload verification, or both) within a SIFS time interval. The AP 102-a may receive the indication of the processing capability 304 for the STA 104-a. The STA 104-a, the AP 102-a, or both may use one or more techniques to accommodate the processing capability 304 of the STA 104-a, such that the STA 104-a may perform the additional verifications in time to provide feedback.

For example, the AP 102-a may transmit one or more MPDUs 306 to the STA 104-a via a link 302-b, the one or more MPDUs 306 soliciting an ACK frame 308 as feedback from the STA 104-a. The STA 104-a may receive the one or more MPDUs 306 and may verify whether the one or more MPDUs 306 are successfully received at the STA 104-a. The STA 104-a may perform MAC header verification (such as using a MAC header integrity check), payload verification (such as using a payload decryption and integrity check, a PN-based replay check, or both), or both on the received MPDUs of the one or more MPDUs 306. In some implementations, the STA 104-a may update a scoreboard to indicate successful or unsuccessful reception of the MPDUs 306 according to the results of the MAC header verification, the payload verification, or both. The STA 104-a may transmit an ACK frame 308 in response to the one or more MPDUs 306 in accordance with the MAC header verification, the payload verification, or both. For example, the ACK frame 308 may include a bit indicating either successful reception or unsuccessful reception for each MPDU of the one or more MPDUs 306.

In some implementations, the AP 102-a may extend a duration of the one or more MPDUs 306 according to the processing capability 304 to provide additional time for the STA 104-a to perform the MAC header verification, the payload verification, or both. Additionally, or alternatively, the STA 104-a may delay transmission of the ACK frame 308 according to a timeline associated with the processing capability 304. Additionally, or alternatively, the STA 104-a may transmit multiple ACK frames 308. For example, the STA 104-a may transmit a first ACK frame 308 within a SIFS time interval and may transmit a second ACK frame 308 after the SIFS time interval, where the second ACK frame 308 may be associated with the MAC header verification, the payload verification, or both and may support the processing capability 304 of the STA 104-a. Such techniques may support a wireless device (such as a STA 104, an AP 102) transmitting feedback and performing duplicate detection according to MAC header verification, payload verification, or both for MPDUs 306, effectively mitigating potential DOS attacks while supporting the processing capability 304 of the wireless device.

In some implementations, a processing capability 304 of a wireless device may be associated with a system architecture. For example, if the AP 102-a operates in a controller-based system, the AP 102-a may send frames (such as a frame including one or more MPDUs 306) to a controller for processing. The AP 102-a may perform an initial FCS check, but the controller may perform MAC header verification, payload verification, or both. Accordingly, the processing capability 304 of the AP 102-a may be affected by the processing latency involved in sending an MPDU to the controller and receiving the results of the MAC header verification, the payload verification, or both. For such a processing latency, the AP 102-a may utilize a delayed ACK frame 308 transmission that indicates whether the one or more MPDUs 306 passed MAC header verification, payload verification, or both, rather than an extended duration of MPDUs, to refrain from using the channel for a significant duration of time (such as greater than a threshold duration).

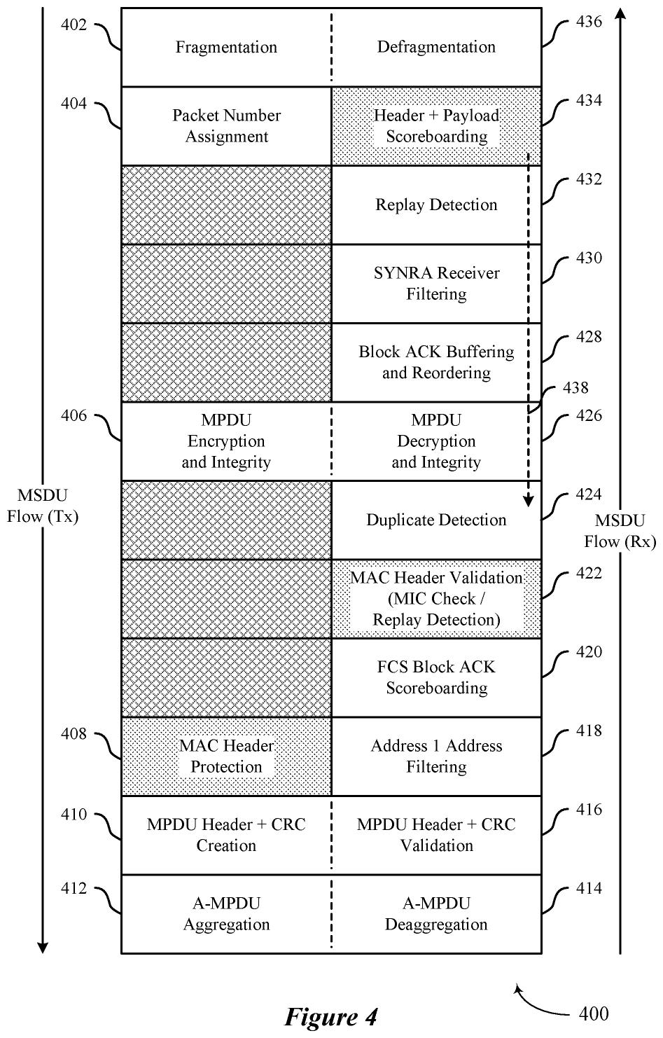

FIG. 4 shows an example of MSDU processing 400 that supports MAC header verification, payload verification, or both. One or more wireless devices, such as STAs 104 or APs 102 as described herein with reference to FIGS. 1 and 3, may perform the MSDU processing 400. In some implementations, operations of the MSDU processing 400 may be performed in a different order or may not be performed. In some implementations, the MSDU processing 400 may include additional operations. A first wireless device (an originator device) may transmit an MPDU including one or more MSDUs in accordance with the MSDU processing 400, and a second wireless device (a recipient device) may receive and process the MPDU in accordance with the MSDU processing 400. The recipient device may perform one or more operations in the MSDU processing 400 to maintain a scoreboard that indicates reception of MPDUs associated with MAC header verification, payload verification, or both. Additionally, or alternatively, the recipient device may perform duplicate detection 424 using MAC header validation 422 or header and payload scoreboarding 434 (such as via feedback 438), instead of FCS BA scoreboarding 420.

An originator device may perform fragmentation 402 to partition MAC information into MPDUs. The originator device may perform PN assignment 404 to assign a PN to an MPDU. The originator device may perform MPDU encryption and integrity 406 to encrypt the payload of the MPDU. In some implementations, the originator device may additionally perform MAC header protection 408, encrypting the MAC header information of the MPDU for additional security. The originator device may perform MPDU header and CRC creation 410 for the MPDU and may perform A-MPDU aggregation 412 to aggregate one or more MPDUs for transmission. The originator device may transmit the one or more MPDUs (such as within an A-MPDU) to a recipient device.

The recipient device may perform A-MPDU deaggregation 414 to determine the one or more MPDUs from the received A-MPDU. The recipient device may perform MPDU header and CRC validation 416 for an MPDU of the A-MPDU. The recipient device may additionally perform Address 1 address filtering 418 and FCS BA scoreboarding 420 for the MPDU. For example, the FCS BA scoreboarding 420 may involve performing an FCS check to determine if the MPDU FCS is verified at the recipient device.

In some implementations, rather than perform duplicate detection 424 using the FCS BA scoreboarding 420, the recipient device may perform the duplicate detection 424 using MAC header validation 422. The MAC header validation 422 may involve a MIC check, MAC header replay detection, or both. The recipient device may verify the SN of the MPDU in accordance with the MAC header validation 422 and may perform duplicate detection 424 according to the MAC header validation 422.

The recipient device may perform an MPDU decryption and integrity check 426 on the payload of the MPDU. The recipient device may perform BA buffering and reordering 428, synthetic receiver address (SYRNA) receiver filtering 430, and replay detection 432 for the MPDU payload. In some implementations, the recipient device may perform header and payload scoreboarding 434 according to the MAC header validation 422, the MPDU decryption and integrity check 426, the replay detection 432, or any combination thereof. For example, the recipient device may update a scoreboard in accordance with whether the MPDU's MAC header, the MPDU's payload, or both are verified. In some implementations, the recipient device may feedback 438 information associated with the header and payload scoreboarding 434 to update the duplicate detection 424. For example, the recipient device may perform duplicate detection 424 using a scoreboard that reflects the status of a verified MDPU payload. The recipient device may update or otherwise undo an entry in duplicate detection 424 or scoreboarding if the payload validation for the MPDU fails. For example, if the recipient device receives two MPDUs with the same SNs, the same MAC headers, but different payloads, the recipient device may refrain from discarding the second of the two MPDUs because the recipient device used payload validation for the duplicate detection 424. The recipient device may additionally perform defragmentation 436 on the decrypted MPDU.

The recipient device may use the MSDU processing 400 to update a scoreboard that indicates successful or unsuccessful reception of MPDUs in accordance with MAC header verification, payload verification, or both. The scoreboard may be an example of any mechanism tracking MPDU reception at the recipient device. For example, the scoreboard may be an example of a bitmap, where each bit in the bitmap corresponds to an SN. If the bit corresponding to a first SN is set to a first bit value (such as 1), the bitmap indicates that the recipient device successfully received the MPDU with the first SN. Due to the MAC header validation 422, the header and payload scoreboarding 434, or both, “successful reception” for an MPDU may indicate that the MPDU passed MAC header verification, payload verification, or both. If the bit corresponding to the first SN is set to a second bit value (such as 0), the bitmap indicates that the recipient device has not successfully received the MPDU with the first SN. For example, the MPDU may not yet have been sent or the recipient device may fail to receive the MPDU.

In some implementations, the recipient device may maintain a single scoreboard associated with verified contents of an MPDU. For example, the recipient device may maintain the single scoreboard to indicate the status of MAC header verification, payload verification, or both for MPDUs. The recipient device may use the header and payload scoreboarding 434 to maintain the single scoreboard.

In some other implementations, the recipient device may maintain multiple scoreboards. For example, the recipient device may maintain an FCS scoreboard and a payload scoreboard. The FCS scoreboard may indicate successful or unsuccessful reception of an MPDU in accordance with an FCS check (such as using the FCS BA scoreboarding 420). In some implementations, the recipient device may transmit an initial ACK frame (such as a BA) within a SIFS time interval in accordance with the FCS scoreboard. An originator device may retransmit an MPDU that failed the FCS check in response to the initial ACK frame. For example, the originator device may queue the MPDU for retransmission according to the initial ACK frame. However, in some implementations, the originator device may refrain from releasing MPDUs from a transmit buffer in response to the initial ACK frame, because the initial ACK frame may not account for MAC header verification or payload verification.

The payload scoreboard may indicate successful or unsuccessful reception of an MPDU associated with verification of the MPDU's payload (such as according to the header and payload scoreboarding 434). The payload scoreboard may be an example of a bitmap with bits corresponding to MPDUs associated with SN values. The recipient device may set a bit of the bitmap corresponding to a first SN to a value indicating successful reception (such as 1) if the MPDU with the first SN passes payload verification, for example, if the MPDU is successfully decrypted, passes an integrity check, and passes a PN-based replay check. The payload scoreboard may indicate the status of verified MPDUs, and the recipient device may use the payload scoreboard for duplicate detection 424. In some implementations, the recipient device may perform the duplicate detection 424 after the MAC header validation 422 but may update the results of the duplicate detection 424 via feedback 438 if the payload validation of the MPDU is unsuccessful.

In some implementations, the recipient device may transmit a second ACK frame (such as a BA) after a SIFS time interval associated with the payload scoreboard. For example, performing the payload verifications may involve a processing time that exceeds the SIFS time interval. The recipient device may transmit the second ACK frame in a next transmission opportunity (TxOP) after the payload verification is complete. An originator device may retransmit an MPDU that failed the MAC header verification, the payload verification, or both in response to the second ACK frame. For example, the originator device may queue the MPDU for retransmission according to the second ACK frame. The originator device may retransmit the queued MPDUs, where the MPDUs may be queued in response to the initial ACK frame or the second ACK frame. Additionally, the originator device may release one or more MPDUs from the transmit buffer in response to the second ACK frame indicating that the one or more MPDUs were successfully received with verified payloads.

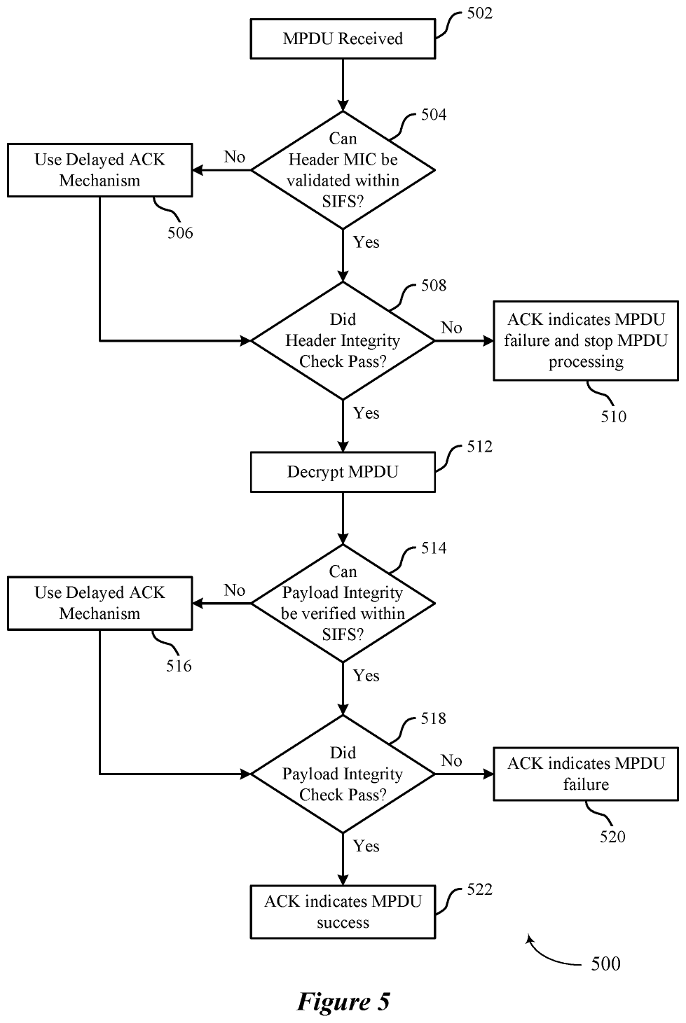

FIG. 5 shows a flowchart illustrating an example process 500 performable by or at a wireless device that supports MAC header and payload integrity checks. The wireless device may be an example of a wireless device, a STA 104, or an AP 102 as described with reference to FIGS. 1, 3, and 4. The example process 500 may include additional, or alternative, operations and, in some implementations, the wireless device may perform the operations of the example process 500 in a different order. The wireless device may perform the example process 500 to transmit an ACK that indicates whether a received MPDUs passes a MAC header verification and a payload verification. In some implementations, the wireless device may use one or more delayed ACK mechanisms in accordance with a processing capability of the wireless device.

At 502, the wireless device may receive an MPDU. At 504, if the wireless device can validate a MAC header of the MPDU within a SIFS time interval, the wireless device may perform the MAC header validation. For example, the wireless device may perform a MIC check for the MAC header. If the wireless device cannot validate the MAC header of the MPDU within the SIFS time interval, the wireless device may use a delayed ACK mechanism at 506. The delayed ACK mechanism may provide the wireless device sufficient time to verify the MAC header. The wireless device may indicate a processing capability (such as a processing delay) in accordance with the wireless device failing to support validating the MAC header of the MPDU within the SIFS time interval. Devices may implement the delayed ACK mechanism associated with the processing capability. For example, a device transmitting the MPDU may prolong or otherwise extend the MPDU, or the wireless device may transmit a delayed ACK frame to accommodate the additional time to perform the MAC header validation. If the MAC header passes a header integrity check at 508, the wireless device may decrypt the MDPU at 512. If the MAC header does not pass the header integrity check at 508, the wireless device may indicate MPDU failure for the MPDU in an ACK frame at 510. The wireless device may additionally stop processing of the MPDU that failed the header integrity check.

For a decrypted MPDU, the wireless device may perform a payload integrity check. At 514, if the wireless device can validate the payload of the MPDU within the SIFS time interval, the wireless device may perform the payload validation. If the wireless device cannot validate the payload of the MPDU within the SIFS time interval, the wireless device may use a delayed ACK mechanism at 516 (such as further in accordance with the processing capability of the wireless device). If the payload passes a payload integrity check at 518, the wireless device may indicate successful reception of the MDPU in an ACK frame at 522. If the payload does not pass the payload integrity check at 518, the wireless device may indicate unsuccessful reception of the MPDU in the ACK frame at 520. The wireless device may additionally stop further processing of the MPDU that failed the payload integrity check.

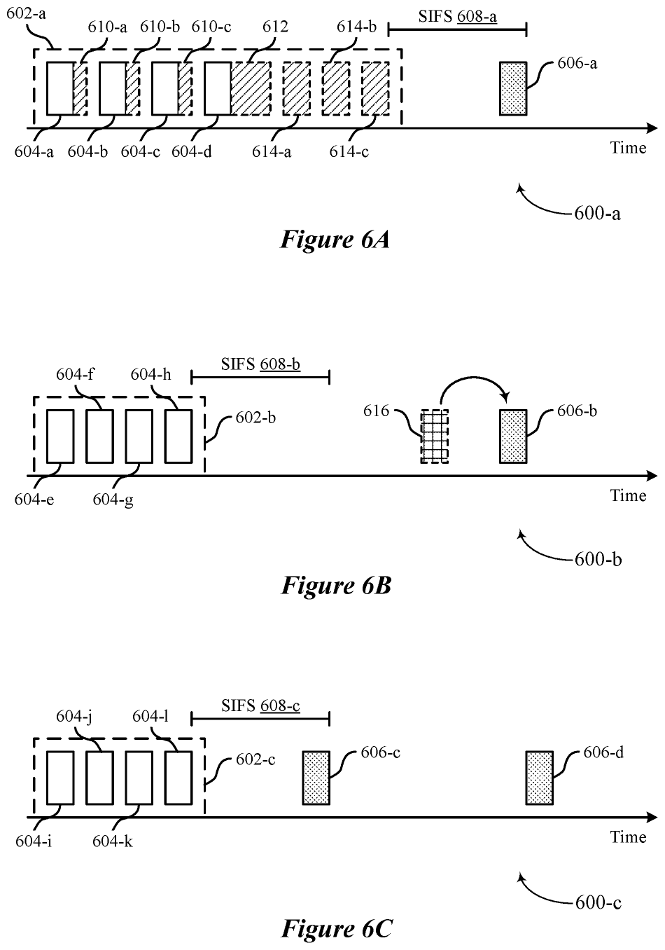

FIG. 6A shows an example of a timeline 600-a that supports ACK frame transmission with MAC header verification, payload verification, or both. A wireless device, such as a wireless device, a STA 104, or an AP 102 as described with reference to FIGS. 1 and 3-5, may communicate according to the timeline 600-a. In some implementations, an originator device may extend a duration of one or more MPDUs to accommodate a processing capability of the wireless device (such as a recipient device). For example, the originator device may extend the duration of the one or more MPDUs (such as using padding) to enable the wireless device to support SIFS-based BA for verified content. The extension of time may allow the wireless device to perform MAC header verification, payload verification, or both and transmit an ACK frame 606-a within a SIFS time interval 608-a.

During association or reassociation, the recipient device may advertise a processing capability associated with performing MAC header verification, payload verification, or both. For example, the recipient device may transmit an indication of a processing latency for performing the MAC header verification, the payload verification, or both. In some aspects, the recipient device may indicate the processing latency using a similar technique to indicating a switching delay for enhanced multilink single-radio (EMLSR) operation. Additionally, or alternatively, the recipient device may transmit an indication of a threshold quantity of MPDUs that the recipient device can verify (such as using MAC header verification, the payload verification, or both) within a SIFS time interval 608-a. The recipient device may transmit a management frame, a beacon frame, an action frame, a probe request frame, a probe response frame, an association request frame, an association response frame, a reassociation request frame, a reassociation response frame, or any combination thereof including one or more fields indicating the processing capability. The originator device may extend the duration of one or more MPDUs to accommodate the processing capability of the recipient device. For example, the extension may provide additional time for the recipient device to perform the MAC header verification, the payload verification, or both within the SIFS time interval 608-a.

The originator device may transmit the one or more MPDUs as an A-MPDU 602-a. The A-MPDU 602-a may include multiple aggregated MPDUs or may include a single MPDU (SMPDU) in accordance with an A-MPDU format. For example, the A-MPDU 602-a may include a first MPDU 604-a, a second MPDU 604-b, a third MPDU 604-c, and a fourth MPDU 604-d. The A-MPDU 602-a may solicit feedback, for example, within the SIFS time interval 608-a. In some implementations, the originator device may add padding after the last MPDU of the A-MPDU 602-a to provide the recipient device sufficient time to process the MAC headers, the payloads, or both for the MPDUs and generate an ACK frame 606-a that indicates verification of the MAC headers, the payloads, or both within the SIFS time interval 608-a. In some implementations, the originator device may add the padding as inter-frame padding between MPDUs. For example, the originator device may add padding 610-a, padding 610-b, padding 610-c, or some combination thereof. Additionally, or alternatively, the originator device may add the padding as end-of-frame (EOF) padding 612 after the last MPDU (such as the fourth MPDU 604-d) of the A-MPDU 602-a. Additionally, or alternatively, the originator device may add the padding as one or more additional frames within the A-MPDU 602-a, such as a frame 614-a, a frame 614-b, and a frame 614-c. In some implementations, the added frames may be examples of quality of service (QOS) null frames (such as after the last MPDU of a PPDU). In some other implementations, the added frames may be examples of one or more repeated MPDUs of the A-MPDU 602-a. By padding the transmission, the originator device may provide the recipient device sufficient time to process the MAC headers and payloads for the MPDUs and generate an ACK (such as the ACK frame 606-a) within the SIFS time interval 608-a that reflects the verified header and payload statuses of the MPDUs.

The SIFS time interval 608-a may start at the end of the A-MPDU 602-a. Accordingly, extending the duration of the A-MPDU 602-a (such as via padding or one or more other techniques) may provide additional time for the recipient device to perform verification processes for the A-MPDU 602-a. For example, the recipient device may perform verification processes for the MPDUs during or otherwise parallel to reception of portions of the A-MPDU 602-a. The recipient device may generate and transmit an ACK frame 606-a (such as a BA) that indicates MAC header verification, payload verification, or both for the A-MPDU 602-a within the SIFS time interval 608-a according to the extended duration of the A-MPDU 602-a accommodating the recipient device's processing capability. For example, the second MPDU 604-b may fail an FCS check and the third MPDU 604-c may fail a payload verification. The ACK frame 606-a may indicate successful reception of the first MPDU 604-a and the fourth MPDU 604-d and may indicate unsuccessful reception of both the second MPDU 604-b and the third MPDU 604-c associated with performing the MAC header verification, payload verification, or both.

FIG. 6B shows an example of a timeline 600-b that supports ACK frame transmission with MAC header verification, payload verification, or both. A wireless device, such as a wireless device, a STA 104, or an AP 102 as described with reference to FIGS. 1 and 3-6A, may communicate according to the timeline 600-b. In some implementations, the wireless device (such as a recipient device) may negotiate a BA agreement with an originator device to transmit a delayed ACK frame 606-b (such as a delayed BA) after the end of a SIFS time interval 608-b.

For example, the originator device and recipient device may negotiate a BA agreement with an ACK Policy set to “Block ACK.” The “Block ACK” ACK Policy may support a delayed transmission of a BA after the end of the SIFS time interval 608-b. Additionally, or alternatively, the devices may negotiate a different ACK Policy type that supports a delayed transmission. The delayed transmission may provide the recipient device sufficient time to perform MAC header verification, payload verification, or both and transmit an ACK frame 606-b that reflects the MAC header verification, payload verification, or both.

The originator device may transmit an A-MPDU 602-b including a first MPDU 604-e, a second MPDU 604-f, a third MPDU 604-g, and a fourth MPDU 604-h. The recipient device may receive the A-MPDU 602-b and may perform MAC header validation, payload validation, or both on the MPDUs. However, a processing latency to perform the validation may exceed the SIFS time interval 608-b.

In some implementations, the originator device may solicit the ACK after a time that satisfies the processing capability (such as the processing latency) of the recipient device. For example, the originator device may transmit a BA request (BAR) frame 616 requesting the ACK frame 606-b transmission after the processing latency specified by the recipient device (such as indicated in accordance with the processing capability of the recipient device). In some implementations, the recipient device may advertise its processing capability (such as a processing latency for verification) to generate a payload-verified (or MAC header-verified) BA during association. The BAR frame 616 may be an example of a protected BAR or an implicit BAR. In some implementations, the recipient device may transmit the delayed ACK without a BAR frame 616. For example, the recipient device may transmit the ACK frame 606-b in a next available TxOP after the payload-verified (or MAC header-verified) BA is generated.

FIG. 6C shows an example of a timeline 600-c that supports ACK frame transmission with MAC header verification, payload verification, or both. A wireless device, such as a wireless device, a STA 104, or an AP 102 as described with reference to FIGS. 1 and 3-6B, may communicate according to the timeline 600-c. In some implementations, the wireless device (such as a recipient device) may transmit multiple ACK frames in response to an A-MPDU 602-c according to a processing capability of the wireless device.

The wireless device (such as the recipient device) may advertise its processing capability (such as a processing latency associated with performing MAC header verification, payload verification, or both) during association. For example, the recipient device may indicate a processing time for generating a second ACK frame 606-d (such as a second BA) that indicates successful or unsuccessful MPDU reception according to checking the MPDU header, payload, or both. The processing time may be greater than a SIFS time interval 608-c, such that the recipient device may fail to generate and transmit an ACK within the SIFS time interval 608-c that indicates the results of MAC header verification, payload verification, or both.

The recipient device may receive an A-MPDU 602-c including a first MPDU 604-i, a second MPDU 604-j, a third MPDU 604-k, and a fourth MPDU 604-1. The recipient device may transmit a first ACK frame 606-c within a SIFS time interval 608-c. In some implementations, the first ACK frame 606-c may be an example of a null ACK transmitted within the SIFS time interval 608-c. The null ACK may indicate that the recipient device received an MPDU (such as the A-MPDU 602-c) and is yet to process the contents of the MPDU. In some other implementations, the first ACK frame 606-c may indicate FCS-based feedback for the A-MPDU 602-c. In response to the first ACK frame 606-c, the originator device may determine if an MPDU is not received by the recipient device and may trigger a retransmission of the MPDU.

The recipient device may transmit a second ACK frame 606-d after the SIFS time interval 608-c. The second ACK frame 606-d may be an example of a delayed BA for verified content (such as verified MAC headers, verified payloads, or both). The recipient device may transmit the second ACK frame 606-d according to a solicitation from the originator device (such as via a protected BAR from the originator device after the indicated processing latency) or may transmit the second ACK frame 606-d unsolicited (such as in a subsequent TxOP that the recipient device may use). The second ACK frame 606-d (such as the delayed ACK) may indicate which MPDUs the recipient device successfully received and validated using MAC header validation, payload validation, or both.

In some implementations, the second MPDU 604-j may fail an FCS check and the third MPDU 604-k may fail a payload verification. The first ACK frame 606-c may indicate successful FCS-based reception of the first MPDU 604-i, the third MPDU 604-k, and the fourth MPDU 604-1 and may indicate unsuccessful FCS-based reception of the second MPDU 604-j. The originator device receiving the first ACK frame 606-c may determine to retransmit the second MPDU 604-j. The second ACK frame 606-d may indicate successful MAC header or payload-based reception of the first MPDU 604-i and the fourth MPDU 604-1 and may indicate unsuccessful MAC header or payload-based reception of the second MPDU 604-j and the third MPDU 604-k. In some implementations, the second ACK frame 606-d may refrain from indicating the second MPDU 604-j because the first ACK frame 606-c already indicated failed reception of the second MPDU 604-j. The originator device receiving the second ACK frame 606-d may determine to retransmit the third MPDU 604-k (such as in addition to the second MPDU 604-j).

In some implementations, an ACK frame as described herein with reference to FIGS. 6A, 6B, and 6C may be an example of a multi-STA BA. Some systems may provide security for multi-STA BA frames, such that wireless devices may use the multi-STA BA frames for secure, trusted ACK information. Additionally, the versatility of the format of the multi-STA BA frame may support including different types of information. For example, the structure of the multi-STA BA frame may include ACK information for MPDUs corresponding to the same or different STAs for different traffic identifiers (TIDs). The ACK information may be organized as repeating per-association identifier (AID) TID information fields.

The format of the multi-STA BA frame may include MIC for the contents of the ACK frame. For example, an AID value, an ACK type value, a TID value, or some combination of these fields or other fields (such as other reserved bits or fields) may indicate the contents of the ACK frame. For example, a first combination of field values (such as for the AID, the ACK type, and the TID fields) may indicate that the multi-STA BA frame indicates FCS-based MPDU reception, a second combination may indicate that the multi-STA BA frame indicates MAC header-based MPDU reception, a third combination may indicate that the multi-STA BA frame indicates payload-based MPDU reception, or any combination thereof. In some implementations, the combination of field values may indicate that the multi-STA BA frame provides some combination of FCS-based validation, MAC header-based validation, and payload-based validation. The multi-STA BA frame may indicate different statuses (such as successful reception or unsuccessful reception) for different MPDUs. Additionally, or alternatively, the multi-STA BA frame may indicate different statuses (such as successful or unsuccessful FCS check, successful or unsuccessful MAC header check, successful or unsuccessful payload check) for a single MPDU. In some implementations, other fields or reserved bits in the BA control field may indicate statuses of header or payload integrity checks. For example, a TID information field, a noMemory Kept field, a MemoryConfigTag field, a MgmtACK field, or any combination of these or other fields may indicate MAC header or payload verification information or may differentiate between an ACK frame indicating FCS-based MPDU reception, an ACK frame indicating MAC header-based MPDU reception, ACK frame indicating payload-based MPDU reception, or any combination thereof.

In some implementations, a wireless device may perform any combination of techniques describe herein with reference to FIGS. 6A, 6B, and 6C to support transmitting MAC header or payload-based feedback in accordance with a processing capability of the wireless device.

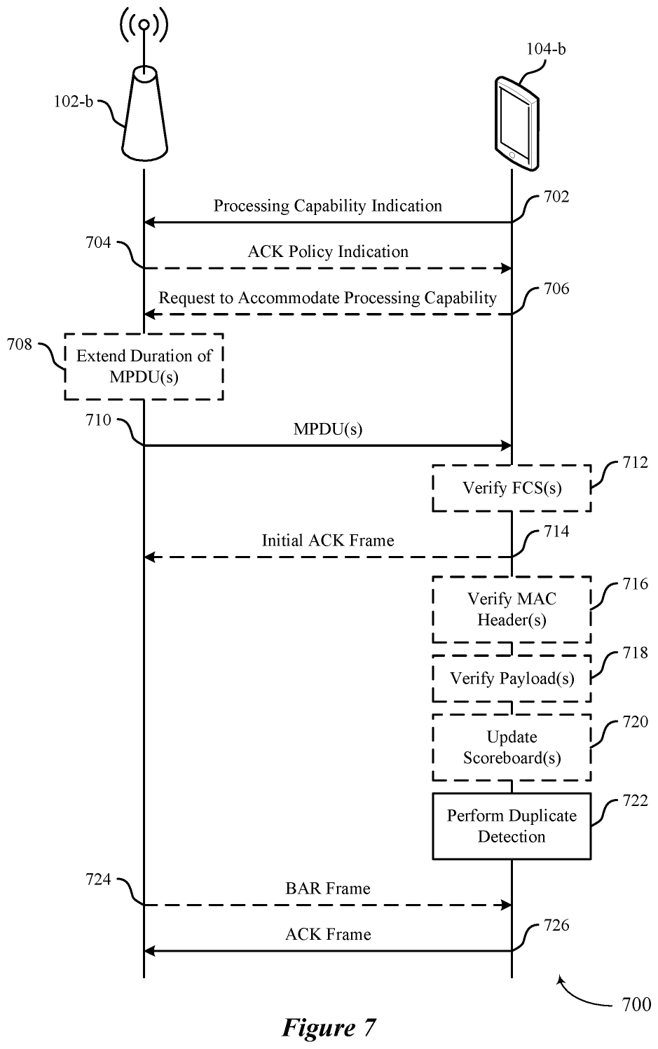

FIG. 7 shows an example of a process flow 700 that supports ACK processing associated with MAC header verification, payload verification, or both. In some implementations, the process flow 700 may be implemented by aspects of the wireless communication network 100 as described herein with reference to FIG. 1. For example, the process flow 700 may include a STA 104-b and an AP 102-b, which may be examples of a STA 104 and an AP 102 as described with reference to FIGS. 1 and 3-6C. In the following description of the process flow 700, the operations between the devices may be performed in different orders or at different times. Some operations may be left out of the process flow 700, or other operations may be added. Although the STA 104-b and the AP 102-b are shown performing the operations of the process flow 700, some aspects of some operations may be performed by one or more other devices. For example, any wireless device (such as a STA 104 or an AP 102) may use the techniques described herein to provide MAC header-based verification, payload-based verification, or both for MPDUs.

At 702, the STA 104-b may transmit an indication of a processing capability associated with verification of a MAC header, a payload, or both. In some implementations, the processing capability may be an example of a processing latency associated with performing the verification of the MAC header, the payload, or both. Additionally, or alternatively, the processing capability may be an example of a threshold quantity of MPDUs for which the STA 104-b may perform the verification within a SIFS time interval. The STA 104-b may transmit the indication of the processing capability to the AP 102-b during association (or reassociation) with the AP 102-b.

In some implementations, at 704, the AP 102-b may negotiate an ACK Policy with the STA 104-b. For example, the ACK Policy may indicate for the STA 104-b to transmit delayed ACK frames to accommodate the processing capability of the STA 104-b. In some implementations, the ACK Policy may indicate “Block ACK,” which may support the delayed ACK transmission.

In some implementations, at 706, the STA 104-b may transmit a request for the AP 102-b to accommodate the processing capability of the STA 104-b. For example, the STA 104-b may transmit a request for a packet extension or some other request for the AP 102-b to extend the duration of an MPDU transmission to support the STA 104-b performing the verification of the MAC header, the payload, or both for the MPDU transmission within the SIFS time interval. In some implementations, at 708, the AP 102-b may extend the duration of one or more MPDUs (such as extending the duration of an A-MPDU or PPDU). The AP 102-b may extend the duration of the one or more MPDUs by adding padding (such as between frames or EOF), adding additional frames (such as null frames or repeated frames), or some combination of these or other techniques to extend the duration of the MPDUs to accommodate the processing capability.

At 710, the AP 102-b may transmit, to the STA 104-b, one or more MPDUs that solicit an ACK frame. The one or more MPDUs may be included in an A-MPDU or PPDU.

At 712, the STA 104-b may perform FCS verification for the one or more MPDUs. In some implementations, at 714, the STA 104-b may transmit an initial ACK frame within the SIFS time interval, the initial ACK frame indicating the results of the FCS verification.

At 716, the STA 104-b may perform MAC header verification for the one or more MPDUs (such as the MPDUs that pass the FCS verification). At 718, the STA 104-b may perform payload verification for the one or more MPDUs (such as the MPDUs that pass the MAC header verification). The STA 104-b may perform the MAC header verification, the payload verification, or both in accordance with the processing capability of the STA 104-b.

At 720, the STA 104-b may update one or more scoreboards, or perform any other techniques for tracking MPDU reception, using the verifications. In some implementations, the STA 104-b may update a single scoreboard indicating MAC header verification, payload verification, or both. In some other implementations, the STA 104-b may maintain multiple scoreboards, one for FCS verification and one for MAC header verification, payload verification, or both. At 722, the STA 104-b may perform duplicate detection using the scoreboard indicating MAC header verification, payload verification, or both.

In some implementations, at 724, the AP 102-b may transmit a BAR frame requesting an ACK from the STA 104-b (such as a delayed ACK after the SIFS time interval).

At 726, the STA 104-b may transmit the ACK frame indicating MPDU reception in accordance with the MAC header verification, the payload verification, or both in accordance with the processing capability. In some implementations, the STA 104-b may transmit the ACK frame within the SIFS time interval according to an additional processing time provided by the AP 102-b extending the duration of the one or more MPDUs. In some other implementations, the STA 104-b may transmit the ACK frame after the SIFS time interval in accordance with using a delayed ACK transmission (such as in response to the BAR frame or otherwise in a subsequent TxOP).

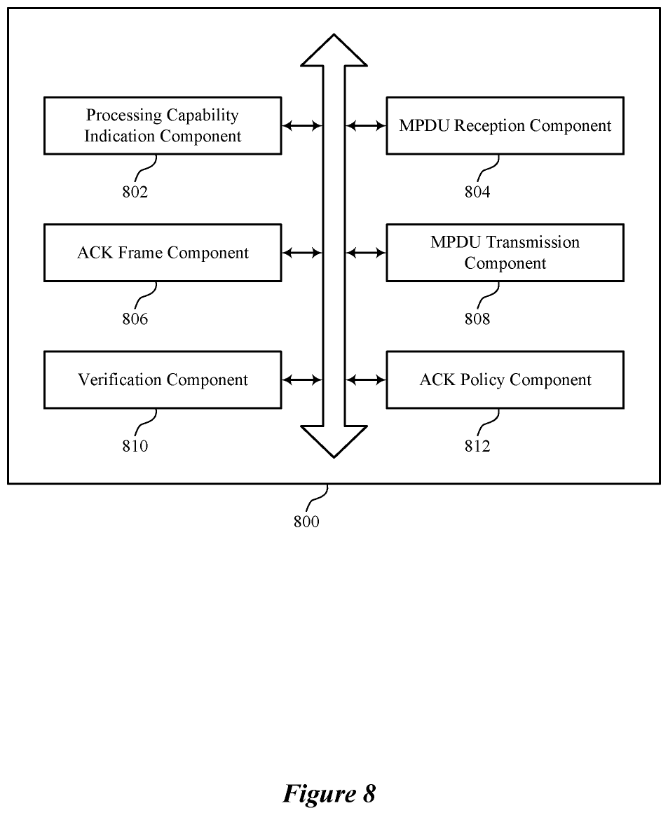

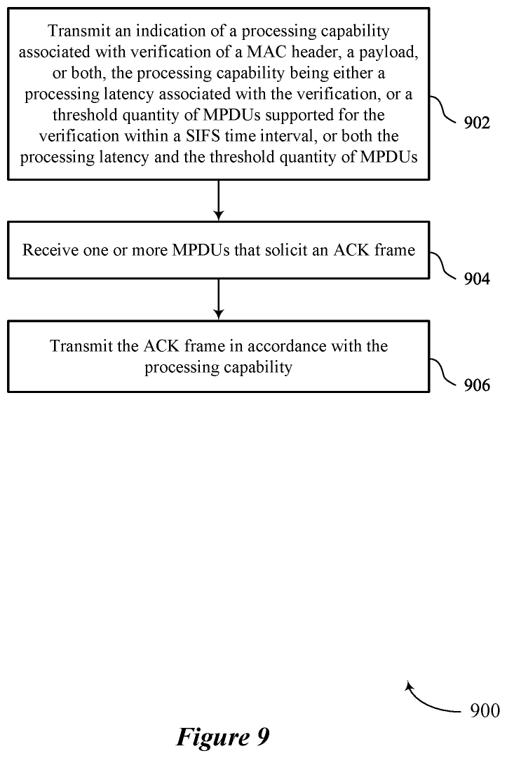

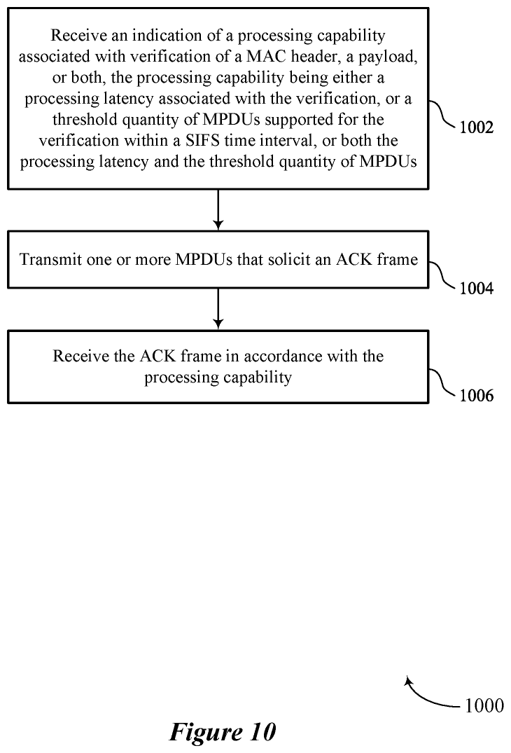

FIG. 8 shows a block diagram of an example wireless communication device 800 that supports ACK processing associated with MAC header verification, payload verification, or both. In some implementations, the wireless communication device 800 is configured to perform the process 900, the process 1000, or both described with reference to FIGS. 9 and 10, respectively. The wireless communication device 800 may include one or more chips, SoCs, chipsets, packages, components or devices that individually or collectively constitute or include a processing system. The processing system may interface with other components of the wireless communication device 800 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without using configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The wireless communication device 800 may be an example or component of any wireless device. In some implementations, the wireless communication device 800 can configurable or configured for use in an AP or STA, such as the AP 102 or the STA 104 described with reference to FIG. 1. In some other implementations, the wireless communication device 800 can be an AP or STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other implementations, the wireless communication device 800 can be configurable or configured to transmit and receive signals and communications conforming to one or more 3GPP specifications including those for 5G NR or 6G. In some implementations, the wireless communication device 800 also includes or can be coupled with one or more application processors which may be further coupled with one or more other memories. In some implementations, the wireless communication device 800 further includes a user interface (UI) (such as a touchscreen or keypad) and a display, which may be integrated with the UI to form a touchscreen display that is coupled with the processing system. In some implementations, the wireless communication device 800 may further include one or more sensors such as, for example, one or more inertial sensors, accelerometers, temperature sensors, pressure sensors, or altitude sensors, that are coupled with the processing system. In some implementations, the wireless communication device 800 further includes at least one external network interface coupled with the processing system that enables communication with a core network or backhaul network that enables the wireless communication device 800 to gain access to external networks including the Internet.

The wireless communication device 800 includes a processing capability indication component 802, an MPDU reception component 804, an ACK frame component 806, an MPDU transmission component 808, a verification component 810, and an ACK policy component 812. Portions of one or more of the processing capability indication component 802, the MPDU reception component 804, the ACK frame component 806, the MPDU transmission component 808, the verification component 810, and the ACK policy component 812 may be implemented at least in part in hardware or firmware. For example, one or more of the processing capability indication component 802, the MPDU reception component 804, the ACK frame component 806, the MPDU transmission component 808, the verification component 810, and the ACK policy component 812 may be implemented at least in part by at least a processor or a modem. In some implementations, portions of one or more of the processing capability indication component 802, the MPDU reception component 804, the ACK frame component 806, the MPDU transmission component 808, the verification component 810, and the ACK policy component 812 may be implemented at least in part by a processor and software in the form of processor-executable code stored in memory.

The wireless communication device 800 may support wireless communications in accordance with examples as disclosed herein. The processing capability indication component 802 is configurable or configured to transmit an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The MPDU reception component 804 is configurable or configured to receive one or more MPDUs that solicit an ACK frame. The ACK frame component 806 is configurable or configured to transmit the ACK frame in accordance with the processing capability.

In some implementations, a duration associated with the one or more MPDUs is extended according to the processing capability. In some implementations, to support transmitting the ACK frame, the ACK frame component 806 is configurable or configured to transmit the ACK frame in accordance with the SIFS time interval according to the duration associated with the one or more MPDUs being extended.

In some implementations, the processing capability indication component 802 is configurable or configured to transmit a request to accommodate the processing capability (such as the processing latency), where the duration associated with the one or more MPDUs is extended in accordance with the request to accommodate the processing capability. In some implementations, the request to accommodate the processing capability includes a request for a packet extension. In some implementations, the duration associated with the one or more MPDUs is extended in accordance with EOF padding, one or more null frames, or both.

In some implementations, the one or more MPDUs correspond to an A-MPDU format. In some implementations, the one or more MPDUs include an A-MPDU or an SMPDU.

In some implementations, the verification component 810 is configurable or configured to verify one or more MAC headers, one or more payloads, or both corresponding to the one or more MPDUs. In some implementations, the verification component 810 is configurable or configured to perform duplicate detection in accordance with the verifying the one or more MAC headers, the one or more payloads, or both, where the ACK frame indicates a result of the duplicate detection.

In some implementations, the verification component 810 is configurable or configured to update a scoreboard to indicate the verified one or more MAC headers, the verified one or more payloads, or both, where the ACK frame is in accordance with the scoreboard. In some implementations, the scoreboard includes a bitmap. In some implementations, a bit of the bitmap indicates whether a corresponding MPDU of the one or more MPDUs passes the verifying. In some implementations, the scoreboard includes a first scoreboard, and the verification component 810 is configurable or configured to verify one or more FCSs corresponding to the one or more MPDUs. In some implementations, the verification component 810 is configurable or configured to update a second scoreboard to indicate the verified one or more FCSs.

In some implementations, the ACK frame is transmitted in accordance with the SIFS time interval.

In some implementations, the ACK frame includes a first ACK frame indicating FCS verification corresponding to the one or more MPDUs, and the ACK frame component 806 is configurable or configured to transmit a second ACK frame indicating the verification corresponding to the one or more MPDUs in accordance with a time interval different than the SIFS time interval according to the processing capability.

In some implementations, to support transmitting the indication of the processing capability, the processing capability indication component 802 is configurable or configured to transmit a management frame, a beacon frame, an action frame, a probe request frame, a probe response frame, an association request frame, an association response frame, a reassociation request frame, a reassociation response frame, or any combination thereof including one or more fields indicating the processing capability.

In some implementations, the ACK policy component 812 is configurable or configured to receive a second indication of an ACK Policy set to Block Ack in accordance with the processing capability, where the ACK frame is transmitted in accordance with a time interval different than the SIFS time interval according to the ACK Policy set to Block Ack. In some implementations, the ACK policy component 812 is configurable or configured to receive a BAR frame indicating the time interval different than the SIFS time interval, where the ACK frame is transmitted further in accordance with the BAR frame.

In some implementations, the ACK frame includes a multi-STA BA frame. In some implementations, the multi-STA BA frame includes an AID, an ACK type indicator, a TID, or any combination thereof that indicate that the ACK frame verifies one or more FCSs, one or more MAC headers, one or more payloads, or any combination thereof corresponding to the one or more MPDUs.

Additionally, or alternatively, the wireless communication device 800 may support wireless communications in accordance with examples as disclosed herein. In some implementations, the processing capability indication component 802 is configurable or configured to receive an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs. The MPDU transmission component 808 is configurable or configured to transmit one or more MPDUs that solicit an ACK frame. In some implementations, the ACK frame component 806 is configurable or configured to receive the ACK frame in accordance with the processing capability.

In some implementations, the MPDU transmission component 808 is configurable or configured to extend a duration associated with the one or more MPDUs according to the processing capability.

In some implementations, the processing capability indication component 802 is configurable or configured to receive a request to accommodate the processing capability, where the duration associated with the one or more MPDUs is extended in accordance with the request to accommodate the processing capability. In some implementations, the request to accommodate the processing capability includes a request for a packet extension. In some implementations, the duration associate with the one or more MPDUs is extended in accordance with EOF padding, one or more null frames, or both. In some implementations, the one or more MPDUs correspond to an A-MPDU format. In some implementations, the one or more MPDUs include an A-MPDU or an SMPDU.

In some implementations, the ACK frame be received in accordance with the SIFS time interval.

In some implementations, the ACK frame includes a first ACK frame indicating FCS verification corresponding to the one or more MPDUs, and the ACK frame component 806 is configurable or configured to receive a second ACK frame indicating the verification corresponding to the one or more MPDUs in accordance with a time interval different than the SIFS time interval according to the processing capability.

In some implementations, the ACK frame component 806 is configurable or configured to refrain from updating a transmit buffer in response to the first ACK frame. In some such examples, the ACK frame component 806 is configurable or configured to update the transmit buffer in response to the second ACK frame instead.

In some implementations, the ACK frame indicates the verification corresponding to the one or more MPDUs in accordance with the processing capability.

In some implementations, to support receiving the indication of the processing capability, the processing capability indication component 802 is configurable or configured to receive a management frame, a beacon frame, an action frame, a probe request frame, a probe response frame, an association request frame, an association response frame, a reassociation request frame, a reassociation response frame, or any combination thereof including one or more fields indicating the processing capability.

In some implementations, the ACK policy component 812 is configurable or configured to transmit a second indication of an ACK policy indicating a BA in accordance with the processing capability, where the ACK frame is received in accordance with a time interval different than the SIFS time interval according to the BA. In some implementations, the ACK policy component 812 is configurable or configured to transmit a BAR frame indicating the time interval different than the SIFS time interval, where the ACK frame is received further in accordance with the BAR frame.

In some implementations, the ACK frame includes a multi-STA BA frame. In some implementations, the multi-STA BA frame includes an AID, an ACK type indicator, a TID, or any combination thereof that indicates that the ACK frame verifies one or more FCSs, one or more MAC headers, one or more payloads, or any combination thereof corresponding to the one or more MPDUs.

FIG. 9 shows a flowchart illustrating an example process 900 performable by or at a wireless device that supports ACK processing associated with MAC header verification, payload verification, or both. The operations of the process 900 may be implemented by a wireless device or its components as described herein. For example, the process 900 may be performed by a wireless communication device, such as the wireless communication device 800 described with reference to FIG. 8, operating as or within a wireless AP or a wireless STA. In some implementations, the process 900 may be performed by a wireless AP or a wireless STA, such as one of the APs 102 or the STAs 104 described with reference to FIG. 1.

In some implementations, in block 902, the wireless device may transmit an indication of a processing capability associated with verification of a MAC header, a payload, or both. The processing capability may be either a processing latency associated with the verification or a threshold quantity of MPDUs supported for the verification within a SIFS time interval, or both the processing latency and the threshold quantity of MPDUs. The operations of block 902 may be performed in accordance with examples as disclosed herein. In some implementations, aspects of the operations of block 902 may be performed by a processing capability indication component 802 as described with reference to FIG. 8.

In some implementations, in block 904, the wireless device may receive one or more MPDUs that solicit an ACK frame. The operations of block 904 may be performed in accordance with examples as disclosed herein. In some implementations, aspects of the operations of block 904 may be performed by an MPDU reception component 804 as described with reference to FIG. 8.

In some implementations, in block 906, the wireless device may transmit the ACK frame in accordance with the processing capability. The operations of block 906 may be performed in accordance with examples as disclosed herein. In some implementations, aspects of the operations of block 906 may be performed by an ACK frame component 806 as described with reference to FIG. 8.

FIG. 10 shows a flowchart illustrating an example process 1000 performable by or at a wireless device that supports ACK processing associated with MAC header verification, payload verification, or both. The operations of the process 1000 may be implemented by a wireless device or its components as described herein. For example, the process 1000 may be performed by a wireless communication device, such as the wireless communication device 800 described with reference to FIG. 8, operating as or within a wireless AP or a wireless STA. In some implementations, the process 1000 may be performed by a wireless AP or a wireless STA, such as one of the APs 102 or the STAs 104 described with reference to FIG. 1.

In some implementations, in block 1002, the wireless device may receive an indication of a processing capability associated with verification of a MAC header, a payload, or both. The processing capability may be either a processing latency associated with the verification or a threshold quantity of MPDUs supported for the verification within a SIFS time interval, or both the processing latency and the threshold quantity of MPDUs. The operations of block 1002 may be performed in accordance with examples as disclosed herein. In some implementations, aspects of the operations of block 1002 may be performed by a processing capability indication component 802 as described with reference to FIG. 8.

In some implementations, in block 1004, the wireless device may transmit one or more MPDUs that solicit an ACK frame. The operations of block 1004 may be performed in accordance with examples as disclosed herein. In some implementations, aspects of the operations of block 1004 may be performed by an MPDU transmission component 808 as described with reference to FIG. 8.

In some implementations, in block 1006, the wireless device may receive the ACK frame in accordance with the processing capability. The operations of block 1006 may be performed in accordance with examples as disclosed herein. In some implementations, aspects of the operations of block 1006 may be performed by an ACK frame component 806 as described with reference to FIG. 8.

Implementation examples are described in the following numbered clauses:

Clause 1: A wireless device, including a processing system that includes processor circuitry and memory circuitry that stores code, the processing system configured to cause the wireless device to output an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, obtain one or more MPDUs that solicit an ACK frame, and output the ACK frame in accordance with the processing capability.

Clause 2: The wireless device of clause 1, where a duration associated with the one or more MPDUs is extended according to the processing capability.

Clause 3: The wireless device of clause 2, where, to output the ACK frame, the processing system is configured to cause the wireless device to output the ACK frame in accordance with the SIFS time interval according to the duration associated with the one or more MPDUs being extended.

Clause 4: The wireless device of either of clauses 2 or 3, where the processing system is further configured to cause the wireless device to output a request to accommodate the processing capability, where the duration associated with the one or more MPDUs is extended in accordance with the request to accommodate the processing capability.

Clause 5: The wireless device of clause 4, where the request to accommodate the processing capability includes a request for a packet extension.

Clause 6: The wireless device of any of clauses 2-5, where the duration associated with the one or more MPDUs is extended in accordance with EOF padding, one or more null frames, or both.

Clause 7: The wireless device of any of clauses 2-6, where the one or more MPDUs correspond to an A-MPDU format, and the one or more MPDUs include an A-MPDU or an SMPDU.

Clause 8: The wireless device of any of clauses 1-7, where the processing system is further configured to cause the wireless device to verify one or more MAC headers, one or more payloads, or both corresponding to the one or more MPDUs and perform duplicate detection in accordance with the verifying the one or more MAC headers, the one or more payloads, or both, where the ACK frame indicates a result of the duplicate detection.

Clause 9: The wireless device of clause 8, where the processing system is further configured to cause the wireless device to update a scoreboard to indicate the verified one or more MAC headers, the verified one or more payloads, or both, where the ACK frame is in accordance with the scoreboard.

Clause 10: The wireless device of clause 9, where the scoreboard includes a bitmap, and a bit of the bitmap indicates whether a corresponding MPDU of the one or more MPDUs passes the verifying.

Clause 11: The wireless device of either of clauses 9 or 10, where the scoreboard includes a first scoreboard, and the processing system is further configured to cause the wireless device to verify one or more FCSs corresponding to the one or more MPDUs and update a second scoreboard to indicate the verified one or more FCSs.

Clause 12: The wireless device of any of clauses 1-11, where the ACK frame is output in accordance with the SIFS time interval.

Clause 13: The wireless device of clause 12, where the ACK frame includes a first ACK frame indicating FCS verification corresponding to the one or more MPDUs, and the processing system is further configured to cause the wireless device to output a second ACK frame indicating the verification corresponding to the one or more MPDUs in accordance with a time interval different than the SIFS time interval according to the processing capability.

Clause 14: The wireless device of any of clauses 1-13, where, to output the indication of the processing capability, the processing system is further configured to cause the wireless device to output a management frame, a beacon frame, an action frame, a probe request frame, a probe response frame, an association request frame, an association response frame, a reassociation request frame, a reassociation response frame, or any combination thereof including one or more fields indicating the processing capability.

Clause 15: The wireless device of any of clauses 1-11 or 14, where the processing system is further configured to cause the wireless device to obtain a second indication of an ACK Policy set to Block Ack in accordance with the processing capability, where the ACK frame is output in accordance with a time interval different than the SIFS time interval according to the ACK Policy set to Block Ack.

Clause 16: The wireless device of clause 15, where the processing system is further configured to cause the wireless device to obtain a BAR frame indicating the time interval different than the SIFS time interval, where the ACK frame is output further in accordance with the BAR frame.

Clause 17: The wireless device of any of clauses 1-16, where the ACK frame includes a multi-STA BA frame, and the multi-STA BA frame includes an AID, an ACK type indicator, a TID, or any combination thereof that indicate that the ACK frame verifies one or more FCSs, one or more MAC headers, one or more payloads, or any combination thereof corresponding to the one or more MPDUs.

Clause 18: A wireless device, including a processing system that includes processor circuitry and memory circuitry that stores code, the processing system configured to cause the wireless device to obtain an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, output one or more MPDUs that solicit an ACK frame, and obtain the ACK frame in accordance with the processing capability.

Clause 19: The wireless device of clause 18, where the processing system is further configured to cause the wireless device to extend a duration associated with the one or more MPDUs according to the processing capability.

Clause 20: The wireless device of clause 19, where the processing system is further configured to cause the wireless device to obtain a request to accommodate the processing capability, where the duration associated with the one or more MPDUs is extended in accordance with the request to accommodate the processing capability.

Clause 21: The wireless device of clause 20, where the request to accommodate the processing capability includes a request for a packet extension.

Clause 22: The wireless device of any of clauses 19-21, where the duration associated with the one or more MPDUs is extended in accordance with EOF padding, one or more null frames, or both.

Clause 23: The wireless device of any of clauses 19-22, where the one or more MPDUs correspond to an A-MPDU format, and the one or more MPDUs include an A-MPDU or an SMPDU.

Clause 24: The wireless device of any of clauses 18-23, where the ACK frame is obtained in accordance with the SIFS time interval.

Clause 25: The wireless device of clause 24, where the ACK frame includes a first ACK frame indicating FCS verification corresponding to the one or more MPDUs, and the processing system is further configured to cause the wireless device to obtain a second ACK frame indicating the verification corresponding to the one or more MPDUs in accordance with a time interval different than the SIFS time interval according to the processing capability.

Clause 26: The wireless device of clause 25, where the processing system is further configured to cause the wireless device to refrain from updating a transmit buffer in response to the first ACK frame and update the transmit buffer in response to the second ACK frame.

Clause 27: The wireless device of any of clauses 18-26, where the ACK frame indicates the verification corresponding to the one or more MPDUs in accordance with the processing capability.

Clause 28: The wireless device of any of clauses 18-27, where, to obtain the indication of the processing capability, the processing system is further configured to cause the wireless device to obtain a management frame, a beacon frame, an action frame, a probe request frame, a probe response frame, an association request frame, an association response frame, a reassociation request frame, a reassociation response frame, or any combination thereof including one or more fields indicating the processing capability.

Clause 29: The wireless device of any of clauses 18-23, 27, or 28, where the processing system is further configured to cause the wireless device to output a second indication of an ACK Policy set to Block Ack in accordance with the processing capability, where the ACK frame is obtained in accordance with a time interval different than the SIFS time interval according to the ACK Policy set to Block Ack.

Clause 30: The wireless device of clause 29, where the processing system is further configured to cause the wireless device to output a BAR frame indicating the time interval different than the SIFS time interval, where the ACK frame is obtained further in accordance with the BAR frame.

Clause 31: The wireless device of any of clauses 18-30, where the ACK frame includes a multi-STA BA frame, and the multi-STA BA frame includes an AID, an ACK type indicator, a TID, or any combination thereof that indicates that the ACK frame verifies one or more FCSs, one or more MAC headers, one or more payloads, or any combination thereof corresponding to the one or more MPDUs.

Clause 32: A method for wireless communications, including transmitting an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, receiving one or more MPDUs that solicit an ACK frame, and transmitting the ACK frame in accordance with the processing capability.

Clause 33: The method of clause 32, where a duration associated with the one or more MPDUs is extended according to the processing capability.

Clause 34: The method of clause 33, where transmitting the ACK frame includes transmitting the ACK frame in accordance with the SIFS time interval according to the duration associated with the one or more MPDUs being extended.

Clause 35: The method of either of clauses 33 or 34, further including transmitting a request to accommodate the processing capability, where the duration associated with the one or more MPDUs is extended in accordance with the request to accommodate the processing capability.

Clause 36: The method of clause 35, where the request to accommodate the processing capability includes a request for a packet extension.

Clause 37: The method of any of clauses 33-36, where the duration associated with the one or more MPDUs is extended in accordance with EOF padding, one or more null frames, or both.

Clause 38: The method of any of clauses 33-37, where the one or more MPDUs correspond to an A-MPDU format, and the one or more MPDUs include an A-MPDU or an SMPDU.

Clause 39: The method of any of clauses 32-38, further including verifying one or more MAC headers, one or more payloads, or both corresponding to the one or more MPDUs, and performing duplicate detection in accordance with the verifying the one or more MAC headers, the one or more payloads, or both, where the ACK frame indicates a result of the duplicate detection.

Clause 40: The method of clause 39, further including updating a scoreboard to indicate the verified one or more MAC headers, the verified one or more payloads, or both, where the ACK frame is in accordance with the scoreboard.

Clause 41: The method of clause 40, where the scoreboard includes a bitmap, and a bit of the bitmap indicates whether a corresponding MPDU of the one or more MPDUs passes the verifying.

Clause 42: The method of either of clauses 40 or 41, where the scoreboard includes a first scoreboard, the method further including verifying one or more FCSs corresponding to the one or more MPDUs and updating a second scoreboard to indicate the verified one or more FCSs.

Clause 43: The method of any of clauses 32-42, where the ACK frame is transmitted in accordance with the SIFS time interval.

Clause 44: The method of clause 43, where the ACK frame includes a first ACK frame indicating FCS verification corresponding to the one or more MPDUs, the method further including transmitting a second ACK frame indicating the verification corresponding to the one or more MPDUs in accordance with a time interval different than the SIFS time interval according to the processing capability.

Clause 45: The method of any of clauses 32-44, where transmitting the indication of the processing capability includes transmitting a management frame, a beacon frame, an action frame, a probe request frame, a probe response frame, an association request frame, an association response frame, a reassociation request frame, a reassociation response frame, or any combination thereof including one or more fields indicating the processing capability.

Clause 46: The method of any of clauses 32-42 or 45, further including receiving a second indication of an ACK Policy set to Block Ack in accordance with the processing capability, where the ACK frame is transmitted in accordance with a time interval different than the SIFS time interval according to the ACK Policy set to Block Ack.

Clause 47: The method of clause 46, further including receiving a BAR frame indicating the time interval different than the SIFS time interval, where the ACK frame is transmitted further in accordance with the BAR frame.

Clause 48: The method of any of clauses 32-47, where the ACK frame includes a multi-STA BA frame, and the multi-STA BA frame includes an AID, an ACK type indicator, a TID, or any combination thereof that indicate that the ACK frame verifies one or more FCSs, one or more MAC headers, one or more payloads, or any combination thereof corresponding to the one or more MPDUs.

Clause 49: A method for wireless communications, including receiving an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, transmitting one or more MPDUs that solicit an ACK frame, and receiving the ACK frame in accordance with the processing capability.

Clause 50: The method of clause 49, further including extending a duration associated with the one or more MPDUs according to the processing capability.

Clause 51: The method of clause 50, further including receiving a request to accommodate the processing capability, where the duration associated with the one or more MPDUs is extended in accordance with the request to accommodate the processing capability.

Clause 52: The method of clause 51, where the request to accommodate the processing capability includes a request for a packet extension.

Clause 53: The method of any of clauses 50-52, where the duration associated with the one or more MPDUs is extended in accordance with EOF padding, one or more null frames, or both.

Clause 54: The method of any of clauses 50-53, where the one or more MPDUs correspond to an A-MPDU format, and the one or more MPDUs include an A-MPDU or an SMPDU.

Clause 55: The method of any of clauses 49-54, where the ACK frame is received in accordance with the SIFS time interval.

Clause 56: The method of clause 55, where the ACK frame includes a first ACK frame indicating FCS verification corresponding to the one or more MPDUs, the method further including receiving a second ACK frame indicating the verification corresponding to the one or more MPDUs in accordance with a time interval different than the SIFS time interval according to the processing capability.

Clause 57: The method of clause 56, further including refraining from updating a transmit buffer in response to the first ACK frame and updating the transmit buffer in response to the second ACK frame.

Clause 58: The method of any of clauses 49-57, where the ACK frame indicates the verification corresponding to the one or more MPDUs in accordance with the processing capability.

Clause 59: The method of any of clauses 49-58, where receiving the indication of the processing capability includes receiving a management frame, a beacon frame, an action frame, a probe request frame, a probe response frame, an association request frame, an association response frame, a reassociation request frame, a reassociation response frame, or any combination thereof including one or more fields indicating the processing capability.

Clause 60: The method of any of clauses 49-54, 58, or 59, further including transmitting a second indication of an ACK Policy set to Block Ack in accordance with the processing capability, where the ACK frame is received in accordance with a time interval different than the SIFS time interval according to the ACK Policy set to Block Ack.

Clause 61: The method of clause 60, further including transmitting a BAR frame indicating the time interval different than the SIFS time interval, where the ACK frame is received further in accordance with the BAR frame.

Clause 62: The method of any of clauses 49-61, where the ACK frame includes a multi-STA BA frame, and the multi-STA BA frame includes an AID, an ACK type indicator, a TID, or any combination thereof that indicates that the ACK frame verifies one or more FCSs, one or more MAC headers, one or more payloads, or any combination thereof corresponding to the one or more MPDUs.

Clause 63: An apparatus for wireless communications, including means for transmitting an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, means for receiving one or more MPDUs that solicit an ACK frame, and means for transmitting the ACK frame in accordance with the processing capability.

Clause 64: The apparatus of clause 63, where a duration associated with the one or more MPDUs is extended according to the processing capability.

Clause 65: The apparatus of clause 64, where the means for transmitting the ACK frame include means for transmitting the ACK frame in accordance with the SIFS time interval according to the duration associated with the one or more MPDUs being extended.

Clause 66: The apparatus of either of clauses 64 or 65, further including means for transmitting a request to accommodate the processing capability, where the duration associated with the one or more MPDUs is extended in accordance with the request to accommodate the processing capability.

Clause 67: The apparatus of clause 66, where the request to accommodate the processing capability includes a request for a packet extension.

Clause 68: The apparatus of any of clauses 64-67, where the duration associated with the one or more MPDUs is extended in accordance with EOF padding, one or more null frames, or both.

Clause 69: The apparatus of any of clauses 64-68, where the one or more MPDUs correspond to an A-MPDU format, and the one or more MPDUs include an A-MPDU or an SMPDU.

Clause 70: The apparatus of any of clauses 63-69, further including means for verifying one or more MAC headers, one or more payloads, or both corresponding to the one or more MPDUs and means for performing duplicate detection in accordance with the verifying the one or more MAC headers, the one or more payloads, or both, where the ACK frame indicates a result of the duplicate detection.

Clause 71: The apparatus of clause 70, further including means for updating a scoreboard to indicate the verified one or more MAC headers, the verified one or more payloads, or both, where the ACK frame is in accordance with the scoreboard.

Clause 72: The apparatus of clause 71, where the scoreboard includes a bitmap, and a bit of the bitmap indicates whether a corresponding MPDU of the one or more MPDUs passes the verifying.

Clause 73: The apparatus of either of clauses 71 or 72, where the scoreboard includes a first scoreboard, the apparatus further including means for verifying one or more FCSs corresponding to the one or more MPDUs and means for updating a second scoreboard to indicate the verified one or more FCSs.

Clause 74: The apparatus of any of clauses 63-73, where the ACK frame is transmitted in accordance with the SIFS time interval.

Clause 75: The apparatus of clause 74, where the ACK frame includes a first ACK frame indicating FCS verification corresponding to the one or more MPDUs, the apparatus further including means for transmitting a second ACK frame indicating the verification corresponding to the one or more MPDUs in accordance with a time interval different than the SIFS time interval according to the processing capability.

Clause 76: The apparatus of any of clauses 63-75, where the means for transmitting the indication of the processing capability include means for transmitting a management frame, a beacon frame, an action frame, a probe request frame, a probe response frame, an association request frame, an association response frame, a reassociation request frame, a reassociation response frame, or any combination thereof including one or more fields indicating the processing capability.

Clause 77: The apparatus of any of clauses 63-73 or 76, further including means for receiving a second indication of an ACK Policy set to Block Ack in accordance with the processing capability, where the ACK frame is transmitted in accordance with a time interval different than the SIFS time interval according to the ACK Policy set to Block Ack.

Clause 78: The apparatus of clause 77, further including means for receiving a BAR frame indicating the time interval different than the SIFS time interval, where the ACK frame is transmitted further in accordance with the BAR frame.

Clause 79: The apparatus of any of clauses 63-78, where the ACK frame includes a multi-STA BA frame, and the multi-STA BA frame includes an AID, an ACK type indicator, a TID, or any combination thereof that indicate that the ACK frame verifies one or more FCSs, one or more MAC headers, one or more payloads, or any combination thereof corresponding to the one or more MPDUs.

Clause 80: An apparatus for wireless communications, including means for receiving an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, means for transmitting one or more MPDUs that solicit an ACK frame, and means for receiving the ACK frame in accordance with the processing capability.

Clause 81: The apparatus of clause 80, further including means for extending a duration associated with the one or more MPDUs according to the processing capability.

Clause 82: The apparatus of clause 81, further including means for receiving a request to accommodate the processing capability, where the duration associated with the one or more MPDUs is extended in accordance with the request to accommodate the processing capability.

Clause 83: The apparatus of clause 82, where the request to accommodate the processing capability includes a request for a packet extension.

Clause 84: The apparatus of any of clauses 81-83, where the duration associated with the one or more MPDUs is extended in accordance with EOF padding, one or more null frames, or both.

Clause 85: The apparatus of any of clauses 81-84, where the one or more MPDUs correspond to an A-MPDU format, and the one or more MPDUs include an A-MPDU or an SMPDU.

Clause 86: The apparatus of any of clauses 80-85, where the ACK frame is received in accordance with the SIFS time interval.

Clause 87: The apparatus of clause 86, where the ACK frame includes a first ACK frame indicating FCS verification corresponding to the one or more MPDUs, the apparatus further including means for receiving a second ACK frame indicating the verification corresponding to the one or more MPDUs in accordance with a time interval different than the SIFS time interval according to the processing capability.

Clause 88: The apparatus of clause 87, further including means for refraining from updating a transmit buffer in response to the first ACK frame and means for updating the transmit buffer in response to the second ACK frame.

Clause 89: The apparatus of any of clauses 80-88, where the ACK frame indicates the verification corresponding to the one or more MPDUs in accordance with the processing capability.

Clause 90: The apparatus of any of clauses 80-89, where the means for receiving the indication of the processing capability include means for receiving a management frame, a beacon frame, an action frame, a probe request frame, a probe response frame, an association request frame, an association response frame, a reassociation request frame, a reassociation response frame, or any combination thereof including one or more fields indicating the processing capability.

Clause 91: The apparatus of any of clauses 80-85, 89, or 90, further including means for transmitting a second indication of an ACK Policy set to Block Ack in accordance with the processing capability, where the ACK frame is received in accordance with a time interval different than the SIFS time interval according to the ACK Policy set to Block Ack.

Clause 92: The apparatus of clause 91, further including means for transmitting a BAR frame indicating the time interval different than the SIFS time interval, where the ACK frame is received further in accordance with the BAR frame.

Clause 93: The apparatus of any of clauses 80-92, where the ACK frame includes a multi-STA BA frame, and the multi-STA BA frame includes an AID, an ACK type indicator, a TID, or any combination thereof that indicates that the ACK frame verifies one or more FCSs, one or more MAC headers, one or more payloads, or any combination thereof corresponding to the one or more MPDUs.

Clause 94: A non-transitory computer-readable medium storing code for wireless communications, the code including instructions executable by one or more processors to transmit an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, receive one or more MPDUs that solicit an ACK frame, and transmit the ACK frame in accordance with the processing capability.

Clause 95: The non-transitory computer-readable medium of clause 94, where a duration associated with the one or more MPDUs is extended according to the processing capability.

Clause 96: The non-transitory computer-readable medium of clause 95, where the instructions to transmit the ACK frame are executable by the one or more processors to transmit the ACK frame in accordance with the SIFS time interval according to the duration associated with the one or more MPDUs being extended.

Clause 97: The non-transitory computer-readable medium of either of clauses 95 or 96, where the instructions are further executable by the one or more processors to transmit a request to accommodate the processing capability, where the duration associated with the one or more MPDUs is extended in accordance with the request to accommodate the processing capability.

Clause 98: The non-transitory computer-readable medium of clause 97, where the request to accommodate the processing capability includes a request for a packet extension.

Clause 99: The non-transitory computer-readable medium of any of clauses 95-98, where the duration associated with the one or more MPDUs is extended in accordance with EOF padding, one or more null frames, or both.

Clause 100: The non-transitory computer-readable medium of any of clauses 95-99, where the one or more MPDUs correspond to an A-MPDU format, and the one or more MPDUs include an A-MPDU or an SMPDU.

Clause 101: The non-transitory computer-readable medium of any of clauses 94-100, where the instructions are further executable by the one or more processors to verify one or more MAC headers, one or more payloads, or both corresponding to the one or more MPDUs and perform duplicate detection in accordance with the verifying the one or more MAC headers, the one or more payloads, or both, where the ACK frame indicates a result of the duplicate detection.

Clause 102: The non-transitory computer-readable medium of clause 101, where the instructions are further executable by the one or more processors to update a scoreboard to indicate the verified one or more MAC headers, the verified one or more payloads, or both, where the ACK frame is in accordance with the scoreboard.

Clause 103: The non-transitory computer-readable medium of clause 102, where the scoreboard includes a bitmap, and a bit of the bitmap indicates whether a corresponding MPDU of the one or more MPDUs passes the verifying.

Clause 104: The non-transitory computer-readable medium of either of clauses 102 or 103, where the scoreboard includes a first scoreboard, and the instructions are further executable by the one or more processors to verify one or more FCSs corresponding to the one or more MPDUs and update a second scoreboard to indicate the verified one or more FCSs.

Clause 105: The non-transitory computer-readable medium of any of clauses 94-104, where the ACK frame is transmitted in accordance with the SIFS time interval.

Clause 106: The non-transitory computer-readable medium of clause 105, where the ACK frame includes a first ACK frame indicating FCS verification corresponding to the one or more MPDUs, and the instructions are further executable by the one or more processors to transmit a second ACK frame indicating the verification corresponding to the one or more MPDUs in accordance with a time interval different than the SIFS time interval according to the processing capability.

Clause 107: The non-transitory computer-readable medium of any of clauses 94-106, where the instructions to transmit the indication of the processing capability are executable by the one or more processors to transmit a management frame, a beacon frame, an action frame, a probe request frame, a probe response frame, an association request frame, an association response frame, a reassociation request frame, a reassociation response frame, or any combination thereof including one or more fields indicating the processing capability.

Clause 108: The non-transitory computer-readable medium of any of clauses 94-104 or 107, where the instructions are further executable by the one or more processors to receive a second indication of an ACK Policy set to Block Ack in accordance with the processing capability, where the ACK frame is transmitted in accordance with a time interval different than the SIFS time interval according to the ACK Policy set to Block Ack.

Clause 109: The non-transitory computer-readable medium of clause 108, where the instructions are further executable by the one or more processors to receive a BAR frame indicating the time interval different than the SIFS time interval, where the ACK frame is transmitted further in accordance with the BAR frame.

Clause 110: The non-transitory computer-readable medium of any of clauses 94-109, where the ACK frame includes a multi-STA BA frame, and the multi-STA BA frame includes an AID, an ACK type indicator, a TID, or any combination thereof that indicate that the ACK frame verifies one or more FCSs, one or more MAC headers, one or more payloads, or any combination thereof corresponding to the one or more MPDUs.

Clause 111: A non-transitory computer-readable medium storing code for wireless communications, the code including instructions executable by one or more processors to receive an indication of a processing capability associated with verification of a MAC header, a payload, or both, the processing capability being either a processing latency associated with the verification, or a threshold quantity of MPDUs supported for the verification within a SIFS time interval, or both the processing latency and the threshold quantity of MPDUs, transmit one or more MPDUs that solicit an ACK frame, and receive the ACK frame in accordance with the processing capability.

Clause 112: The non-transitory computer-readable medium of clause 111, where the instructions are further executable by the one or more processors to extend a duration associated with the one or more MPDUs according to the processing capability.

Clause 113: The non-transitory computer-readable medium of clause 112, where the instructions are further executable by the one or more processors to receive a request to accommodate the processing capability, where the duration associated with the one or more MPDUs is extended in accordance with the request to accommodate the processing capability.

Clause 114: The non-transitory computer-readable medium of clause 113, where the request to accommodate the processing capability includes a request for a packet extension.

Clause 115: The non-transitory computer-readable medium of any of clauses 112-114, where the duration associated with the one or more MPDUs is extended in accordance with EOF padding, one or more null frames, or both.

Clause 116: The non-transitory computer-readable medium of any of clauses 112-115, where the one or more MPDUs correspond to an A-MPDU format, and the one or more MPDUs include an A-MPDU or an SMPDU.

Clause 117: The non-transitory computer-readable medium of any of clauses 111-116, where the ACK frame is received in accordance with the SIFS time interval.

Clause 118: The non-transitory computer-readable medium of clause 117, where the ACK frame includes a first ACK frame indicating FCS verification corresponding to the one or more MPDUs, and the instructions are further executable by the one or more processors to receive a second ACK frame indicating the verification corresponding to the one or more MPDUs in accordance with a time interval different than the SIFS time interval according to the processing capability.

Clause 119: The non-transitory computer-readable medium of clause 118, where the instructions are further executable by the one or more processors to refrain from updating a transmit buffer in response to the first ACK frame and update the transmit buffer in response to the second ACK frame.

Clause 120: The non-transitory computer-readable medium of any of clauses 111-119, where the ACK frame indicates the verification corresponding to the one or more MPDUs in accordance with the processing capability.

Clause 121: The non-transitory computer-readable medium of any of clauses 111-120, where the instructions to receive the indication of the processing capability are executable by the one or more processors to receive a management frame, a beacon frame, an action frame, a probe request frame, a probe response frame, an association request frame, an association response frame, a reassociation request frame, a reassociation response frame, or any combination thereof including one or more fields indicating the processing capability.

Clause 122: The non-transitory computer-readable medium of any of clauses 111-116, 120, or 121, where the instructions are further executable by the one or more processors to transmit a second indication of an ACK Policy set to Block Ack in accordance with the processing capability, where the ACK frame is received in accordance with a time interval different than the SIFS time interval according to the ACK Policy set to Block Ack.

Clause 123: The non-transitory computer-readable medium of clause 122, where the instructions are further executable by the one or more processors to transmit a BAR frame indicating the time interval different than the SIFS time interval, where the ACK frame is received further in accordance with the BAR frame.

Clause 124: The non-transitory computer-readable medium of any of clauses 111-123, where the ACK frame includes a multi-STA BA frame, and the multi-STA BA frame includes an AID, an ACK type indicator, a TID, or any combination thereof that indicates that the ACK frame verifies one or more FCSs, one or more MAC headers, one or more payloads, or any combination thereof corresponding to the one or more MPDUs.

Clause 125: A wireless device, including a processing system that includes processor circuitry and memory circuitry that stores code, the processing system configured to cause the wireless device to obtain one or more MPDUs that solicit an ACK frame and output the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

Clause 126: A wireless device, including a processing system that includes processor circuitry and memory circuitry that stores code, the processing system configured to cause the wireless device to output one or more MPDUs that solicit an ACK frame and obtain the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

Clause 127: A method for wireless communications, including receiving one or more MPDUs that solicit an ACK frame and transmitting the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

Clause 128: A method for wireless communications, including transmitting one or more MPDUs that solicit an ACK frame and receiving the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

Clause 129: An apparatus for wireless communications, including means for receiving one or more MPDUs that solicit an ACK frame and means for transmitting the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

Clause 130: An apparatus for wireless communications, including means for transmitting one or more MPDUs that solicit an ACK frame and means for receiving the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

Clause 131: A non-transitory computer-readable medium storing code for wireless communications, the code including instructions executable by one or more processors to receive one or more MPDUs that solicit an ACK frame and transmit the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

Clause 132: A non-transitory computer-readable medium storing code for wireless communications, the code including instructions executable by one or more processors to transmit one or more MPDUs that solicit an ACK frame and receive the ACK frame in accordance with a processing capability associated with verification of a MAC header, a payload, or both associated with an MPDU of the one or more MPDUs, the processing capability being either a processing latency associated with the verification, or a threshold quantity of MPDUs supported for the verification within a SIFS time interval, or both the processing latency and the threshold quantity of MPDUs.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A wireless device, comprising:
a processing system that includes processor circuitry and memory circuitry that stores code, the processing system configured to cause the wireless device to:
output an indication of a processing capability associated with verification of a medium access control (MAC) header, a payload, or both, the processing capability being either:
a processing latency associated with the verification, or
a threshold quantity of MAC protocol data units (MPDUs) supported for the verification within a short interframe spacing (SIFS) time interval, or
both the processing latency and the threshold quantity of MPDUs;
obtain one or more MPDUs that solicit an acknowledgment frame; and
output the acknowledgment frame in accordance with the processing capability.

2. The wireless device of claim 1, wherein a duration associated with the one or more MPDUs is extended according to the processing capability.

3. The wireless device of claim 2, wherein, to output the acknowledgment frame, the processing system is configured to cause the wireless device to:
output the acknowledgment frame in accordance with the SIFS time interval according to the duration associated with the one or more MPDUs being extended.

4. The wireless device of claim 2, wherein the processing system is further configured to cause the wireless device to:
output a request to accommodate the processing capability, wherein the duration associated with the one or more MPDUs is extended in accordance with the request to accommodate the processing capability.

5. The wireless device of claim 4, wherein the request to accommodate the processing capability comprises a request for a packet extension.

6. The wireless device of claim 2, wherein the duration associated with the one or more MPDUs is extended in accordance with end-of-frame padding, one or more null frames, or both.

7. The wireless device of claim 2, wherein:
the one or more MPDUs correspond to an aggregate-MPDU (A-MPDU) format; and
the one or more MPDUs comprise an A-MPDU or a single MPDU (SMPDU).

8. The wireless device of claim 1, wherein the processing system is further configured to cause the wireless device to:
verify one or more MAC headers, one or more payloads, or both corresponding to the one or more MPDUs; and
perform duplicate detection in accordance with the verifying the one or more MAC headers, the one or more payloads, or both, wherein the acknowledgment frame indicates a result of the duplicate detection.

9. The wireless device of claim 8, wherein the processing system is further configured to cause the wireless device to:
update a scoreboard to indicate the verified one or more MAC headers, the verified one or more payloads, or both, wherein the acknowledgment frame is in accordance with the scoreboard.

10. The wireless device of claim 9, wherein:
the scoreboard comprises a bitmap; and
a bit of the bitmap indicates whether a corresponding MPDU of the one or more MPDUs passes the verifying.

11. The wireless device of claim 9, wherein the scoreboard comprises a first scoreboard, and the processing system is further configured to cause the wireless device to:
verify one or more frame check sequences (FCSs) corresponding to the one or more MPDUs; and
update a second scoreboard to indicate the verified one or more FCSs.

12. The wireless device of claim 1, wherein the acknowledgment frame is output in accordance with the SIFS time interval.

13. The wireless device of claim 12, wherein the acknowledgment frame comprises a first acknowledgment frame indicating frame check sequence (FCS) verification corresponding to the one or more MPDUs, and the processing system is further configured to cause the wireless device to:
output a second acknowledgment frame indicating the verification corresponding to the one or more MPDUs in accordance with a time interval different than the SIFS time interval according to the processing capability.

14. The wireless device of claim 1, wherein, to output the indication of the processing capability, the processing system is configured to cause the wireless device to:
output a management frame, a beacon frame, an action frame, a probe request frame, a probe response frame, an association request frame, an association response frame, a reassociation request frame, a reassociation response frame, or any combination thereof comprising one or more fields indicating the processing capability.

15. The wireless device of claim 1, wherein the processing system is further configured to cause the wireless device to:
obtain a second indication of an acknowledgment policy set to Block Ack in accordance with the processing capability, wherein the acknowledgment frame is output in accordance with a time interval different than the SIFS time interval according to the acknowledgment policy set to Block Ack.

16. The wireless device of claim 15, wherein the processing system is further configured to cause the wireless device to:
obtain a block acknowledgment request frame indicating the time interval different than the SIFS time interval, wherein the acknowledgment frame is output further in accordance with the block acknowledgment request frame.

17. The wireless device of claim 1, wherein:
the acknowledgment frame comprises a multi-station (STA) block acknowledgment frame; and
the multi-STA block acknowledgment frame comprises an association identifier, an acknowledgment type indicator, a traffic identifier, or any combination thereof that indicate that the acknowledgment frame verifies one or more frame check sequences (FCSs), one or more MAC headers, one or more payloads, or any combination thereof corresponding to the one or more MPDUs.

18. A wireless device, comprising:
a processing system that includes processor circuitry and memory circuitry that stores code, the processing system configured to cause the wireless device to:
obtain an indication of a processing capability associated with verification of a medium access control (MAC) header, a payload, or both, the processing capability being either:
a processing latency associated with the verification, or
a threshold quantity of MAC protocol data units (MPDUs) supported for the verification within a short interframe spacing (SIFS) time interval, or
both the processing latency and the threshold quantity of MPDUs;
output one or more MPDUs that solicit an acknowledgment frame; and
obtain the acknowledgment frame in accordance with the processing capability.

19. The wireless device of claim 18, wherein the processing system is further configured to cause the wireless device to:
extend a duration associated with the one or more MPDUs according to the processing capability.

20. The wireless device of claim 19, wherein the processing system is further configured to cause the wireless device to:
obtain a request to accommodate the processing capability, wherein the duration associated with the one or more MPDUs is extended in accordance with the request to accommodate the processing capability.

21-23. (canceled)

24. The wireless device of claim 18, wherein the acknowledgment frame is obtained in accordance with the SIFS time interval.

25. The wireless device of claim 24, wherein the acknowledgment frame comprises a first acknowledgment frame indicating frame check sequence (FCS) verification corresponding to the one or more MPDUs, and the processing system is further configured to cause the wireless device to:
obtain a second acknowledgment frame indicating the verification corresponding to the one or more MPDUs in accordance with a time interval different than the SIFS time interval according to the processing capability.

26-31. (canceled)

32. A method for wireless communications, comprising:
transmitting an indication of a processing capability associated with verification of a medium access control (MAC) header, a payload, or both, the processing capability being either:
a processing latency associated with the verification, or
a threshold quantity of MAC protocol data units (MPDUs) supported for the verification within a short interframe spacing (SIFS) time interval, or
both the processing latency and the threshold quantity of MPDUs;
receiving one or more MPDUs that solicit an acknowledgment frame; and
transmitting the acknowledgment frame in accordance with the processing capability.

33. The method of claim 32, wherein a duration associated with the one or more MPDUs is extended according to the processing capability.

34. The method of claim 33, wherein transmitting the acknowledgment frame comprises:
transmitting the acknowledgment frame in accordance with the SIFS time interval according to the duration associated with the one or more MPDUs being extended.

35. The method of claim 33, further comprising:
transmitting a request to accommodate the processing capability, wherein the duration associated with the one or more MPDUs is extended in accordance with the request to accommodate the processing capability.

36-38. (canceled)

39. The method of claim 32, further comprising:
verifying one or more MAC headers, one or more payloads, or both corresponding to the one or more MPDUs; and
performing duplicate detection in accordance with the verifying the one or more MAC headers, the one or more payloads, or both, wherein the acknowledgment frame indicates a result of the duplicate detection.

40-48. (canceled)

49. A method for wireless communications, comprising:
receiving an indication of a processing capability associated with verification of a medium access control (MAC) header, a payload, or both, the processing capability being either:
a processing latency associated with the verification, or
a threshold quantity of MAC protocol data units (MPDUs) supported for the verification within a short interframe spacing (SIFS) time interval, or
both the processing latency and the threshold quantity of MPDUs;
transmitting one or more MPDUs that solicit an acknowledgment frame; and
receiving the acknowledgment frame in accordance with the processing capability.

50. The method of claim 49, further comprising:
extending a duration associated with the one or more MPDUs according to the processing capability.

51. The method of claim 50, further comprising:
receiving a request to accommodate the processing capability, wherein the duration associated with the one or more MPDUs is extended in accordance with the request to accommodate the processing capability.

52-62. (canceled)
